(19) United States
(12) Patent Application Publication
(10) Pub. No.: US 2025/0063620 A1
(43) Pub. Date: Feb. 20, 2025

(54) Communication Method, Access Point Multi-Link Device, and Non-Access Point Multi-Link Device

(71) Applicant: Huawei Technologies Co., Ltd., Shenzhen (CN)

(72) Inventors: Guogang Huang, Shenzhen (CN); Yuchen Guo, Shenzhen (CN); Ming Gan, Shenzhen (CN); Yunbo Li, Shenzhen (CN)

(21) Appl. No.: 18/939,914

(22) Filed: Nov. 7, 2024

Related U.S. Application Data
(63) Continuation of application No. PCT/CN2023/091238, filed on Apr. 27, 2023.

(30) Foreign Application Priority Data
May 9, 2022 (CN) 202210499825.7

(51) Int. Cl. H04W 76/15; H04W 8/14; H04W 84/12

(52) U.S. Cl. CPC H04W 76/15; H04W 8/14; H04W 84/12

(57) ABSTRACT

A communication method includes an access point (AP) multi-link device (MLD) that generates first signaling via an affiliated AP affiliated to the AP MLD, where the first signaling indicates a mapping relationship between a traffic identifier and a link, and the mapping relationship indicated by the first signaling periodically takes effect; and the AP MLD sends, via the affiliated AP, the first signaling to a non-AP MLD associated with the AP MLD. The mapping relationship indicated by the sent first signaling periodically takes effect.

### CROSS-REFERENCE TO RELATED APPLICATIONS

This is a continuation of International Patent Application No. PCT/CN2023/091238 filed on Apr. 27, 2023, which claims priority to Chinese Patent Application No. 202210499825.7 filed on May 9, 2022. The disclosures of the aforementioned applications are hereby incorporated by reference in their entireties.

### TECHNICAL FIELD

This disclosure relates to the field of communication technologies, and in particular, to a communication method, an access point (AP) multi-link device (MLD), and a non-AP MLD.

### BACKGROUND

Data traffic rapidly increases with development of the mobile Internet and popularization of smart terminals. A wireless local area network (WLAN) technology becomes one of mainstream mobile broadband access technologies due to advantages of a high rate and low costs. A concept of an MLD is proposed in a protocol applied to a WLAN. The MLD may be an AP MLD or may be a non-AP MLD.

When a non-AP MLD is associated with an AP MLD, because there are multiple links, different data traffic may be mapped to different links based on traffic identifiers (TIDs) to provide differentiated quality of service (QOS). For example, the AP MLD broadcasts a TID-to-link mapping for all associated non-AP MLDs.

A signaling design of the TID-to-link mapping supports only an aperiodic TID-to-link mapping. Therefore, how to design to support a periodic TID-to-link mapping becomes an urgent problem to be resolved.

### SUMMARY

This disclosure provides a communication method. In a multi-link scenario, first signaling that is sent by an AP MLD and that indicates a mapping relationship between a traffic identifier and a link periodically takes effect, to reduce signaling overheads.

According to a first aspect, a communication method is provided. The method may be performed by an AP MLD, or may be performed by a component (for example, a chip or a circuit) of an AP MLD. This is not limited. For ease of description, the following uses an example in which the method is performed by the AP MLD for description.

The method includes that the AP MLD generates first signaling via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively, and the AP MLD sends, via the affiliated AP, the first signaling to a non-AP MLD associated with the AP MLD. The traffic identifier identifies data traffic, and the link is a transmission link between the AP MLD and the non-AP MLD. The mapping relationship between the traffic identifier and the link indicates that different data traffic is mapped to different links.

Based on the foregoing technical solution, the mapping relationship indicated by the first signaling sent by the AP MLD periodically takes effect. This helps periodically indicate the mapping relationship between the traffic identifier and the link to support a more complex application scenario, and avoid repeatedly sending, for multiple times, indication information indicating the mapping relationship between the traffic identifier and the link, thereby reducing signaling overheads.

With reference to the first aspect, in some implementations of the first aspect, the first signaling further includes fourth indication information. The fourth indication information indicates a count of times that the mapping relationship takes effect. The count of times that the mapping relationship takes effect is greater than 1.

Based on the foregoing technical solution, the first signaling can further include information indicating the count of times that the mapping relationship takes effect. This helps the non-AP MLD learn a count of times that the mapping relationship can take effect.

In a special case, when a value of the fourth indication information is 1, it indicates that the mapping relationship indicated by the first signaling aperiodically takes effect. In other words, when the first signaling includes the fourth indication information, and the value of the fourth indication information is 1, it indicates that the mapping relationship indicated by the first signaling aperiodically takes effective. When the first signaling includes the fourth indication information, and the value of the fourth indication information is greater than 1, it indicates that the mapping relationship indicated by the first signaling periodically takes effect.

In another special case, that the mapping relationship indicated by the first signaling periodically takes effect or aperiodically takes effect may alternatively be indicated without using the fourth indication information. To be specific, the first signaling does not include the fourth indication information, and that the mapping relationship indicated by the first signaling periodically takes effect or aperiodically takes effect may alternatively be indicated in another manner. For example, if the third indication information is set to a special value, for example, 0 or 255, it indicates that the mapping relationship indicated by the first signaling aperiodically takes effect. If the third indication information is not set to a special value, the mapping relationship indicated by the first signaling periodically takes effect.

In the special case, the mapping relationship indicated by the first signaling supports aperiodically taking effect and also supports periodically taking effect. This expands an application scenario of the first signaling.

With reference to the first aspect, in some implementations of the first aspect, that the AP MLD sends, via the affiliated AP, the first signaling to a non-AP MLD associated with the AP MLD includes that the AP MLD sends, via the affiliated AP, a beacon frame to the non-AP MLD associated with the AP MLD, where the beacon frame includes the first signaling.

Based on the foregoing technical solution, the first signaling can be sent using an existing frame. This improves backward compatibility of the solution.

With reference to the first aspect, in some implementations of the first aspect, that the first signaling indicates a mapping relationship between a traffic identifier and a link includes that the first signaling indicates that no traffic identifier is mapped to a link of a first affiliated AP in a time period in which the mapping relationship takes effect. The method further includes that the AP MLD performs data send/receiving in the time period via a second affiliated AP through radio frequency transmit/receive chains of the first affiliated AP and the second affiliated AP.

Based on the foregoing technical solution, the first signaling can indicate that no traffic identifier is mapped to the link of the first affiliated AP affiliated to the AP MLD in the time period in which the mapping relationship takes effect, which indicates that, in the time period in which the mapping relationship takes effect, the first affiliated AP is not allowed to perform data sending/receiving through the radio frequency transmit/receive chain of the first affiliated AP and the non-AP MLD is not allowed to send data to the first affiliated AP either. In this way, in the time period in which the mapping relationship takes effect, another affiliated AP (for example, the second affiliated AP) affiliated to the AP MLD can perform data sending/receiving through a radio frequency transmit/receive chain of the other affiliated AP, and can also perform data sending/receiving through the radio frequency transmit/receive chain of the first affiliated AP. This increases a transmission rate between the second affiliated AP and a station associated with the second affiliated AP.

With reference to the first aspect, in some implementations of the first aspect, that the first signaling indicates a mapping relationship between a traffic identifier and a link includes that the first signaling indicates that no traffic identifier is mapped to a link of a first affiliated AP in a time period in which the mapping relationship takes effect. The method further includes that the AP MLD sends second signaling to a first station via a second affiliated AP, where the second signaling indicates the first station to communicate with the second affiliated AP in a time period in which the first station is woken up, and the AP MLD performs data sending/receiving via the second affiliated AP through radio frequency transmit/receive chains of the first affiliated AP and the second affiliated AP in the time period in which the first station is woken up, where the first station is a station associated with the second affiliated AP, a start time of the time period in which the first station is woken up is a first threshold later than a start time of a corresponding time period in which the mapping relationship takes effect, an end time of the time period in which the first station is woken up is the first threshold earlier than an end time of the corresponding time period in which the mapping relationship takes effect, and a count of time periods in which the first station is woken up is the same as a count of time periods in which the mapping relationship takes effect.

For example, the second signaling includes information indicating a start time at which the first station is woken up for a 1st time, information indicating duration in which the first station is woken up each time, and information indicating an interval between start times or end times at which the first station is woken up twice consecutively.

Based on the foregoing technical solution, the first signaling can indicate that no traffic identifier is mapped to the link of the first affiliated AP affiliated to the AP MLD in the time period in which the mapping relationship takes effect, which indicates that, in the time period in which the mapping relationship takes effect, the first affiliated AP is not allowed to perform data sending/receiving through the radio frequency transmit/receive chain of the first affiliated AP and another affiliated AP (for example, the second affiliated AP) affiliated to the AP MLD can indicate, using the second signaling, the first station associated with the second affiliated AP to be woken up, in the time period in which the first station is woken up, to communicate with the second affiliated AP. The time period in which the first station is woken up can be the same as the time period in which the mapping relationship takes effect. Alternatively, the start time of the time period in which the first station is woken up is the first threshold later than the start time of the corresponding time period in which the mapping relationship takes effect, and the end time of the time period in which the first station is woken up is the first threshold earlier than the end time of the corresponding time period in which the mapping relationship takes effect. In the time period in which the first station is woken up, the second affiliated AP can perform data sending/receiving through the radio frequency transmit/receive chain of the second affiliated AP, and can also perform data sending/receiving through the radio frequency transmit/receive chain of the first affiliated AP. This increases a transmission rate between the second affiliated AP and a station associated with the second affiliated AP, and the first station can be in a power-saving mode at a time without the time period in which the first station is woken up.

With reference to the first aspect, in some implementations of the first aspect, the method further includes that the AP MLD receives a request message from the first station via the second affiliated AP, where the request message is used to request the second affiliated AP to periodically trigger scheduling of the first station for uplink transmission, and the request message includes information indicating an interval between two adjacent times of triggering of scheduling.

With reference to the first aspect, in some implementations of the first aspect, the request message further includes at least one of the following information: information indicating a start time for triggering scheduling, a service time for triggering scheduling each time, information used to determine a service time for triggering scheduling each time, information indicating an access policy, information for requesting a long-range transmission mode service, or information used to determine whether to use a long-range transmission mode service.

With reference to the first aspect, in some implementations of the first aspect, that an AP MLD generates first signaling via an affiliated AP affiliated to the AP MLD includes that the AP MLD generates, via the affiliated AP, the first signaling based on the information included in the request message.

According to a second aspect, a communication method is provided. The method may be performed by a non-AP MLD, or may be performed by a component (for example, a chip or a circuit) of a non-AP MLD. This is not limited. For ease of description, the following uses an example in which the method is performed by the non-AP MLD for description.

The communication method includes that the non-AP MLD associated with an AP MLD receives first signaling sent by the AP MLD via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively, and the non-AP MLD determines a transmission link for data traffic based on the first signaling.

With reference to the second aspect, in some implementations of the second aspect, the first signaling further includes fourth indication information. The fourth indication information indicates a count of times that the mapping relationship takes effect. The count of times that the mapping relationship takes effect is greater than 1.

With reference to the second aspect, in some implementations of the second aspect, that a non-AP MLD receives first signaling sent by the AP MLD via an affiliated AP affiliated to the AP MLD includes that the non-AP MLD receives a beacon frame sent by the AP MLD via the affiliated AP affiliated to the AP MLD, where the beacon frame includes the first signaling.

With reference to the second aspect, in some implementations of the second aspect, that the first signaling indicates a mapping relationship between a traffic identifier and a link includes that the first signaling indicates that no traffic identifier is mapped to a link of a first affiliated AP in a time period in which the mapping relationship takes effect. The method further includes that the non-AP MLD receives second signaling from a second affiliated AP, where the second signaling indicates a first station to communicate with the second affiliated AP in a time period in which the first station is woken up, where the first station is a station associated with the second affiliated AP, a start time of the time period in which the first station is woken up is a first threshold later than a start time of a corresponding time period in which the mapping relationship takes effect, an end time of the time period in which the first station is woken up is the first threshold earlier than an end time of the corresponding time period in which the mapping relationship takes effect, and a count of time periods in which the first station is woken up is the same as a count of time periods in which the mapping relationship takes effect.

With reference to the second aspect, in some implementations of the second aspect, the method further includes that the non-AP MLD sends a request message to the second affiliated AP, where the request message is used to request the second affiliated AP to periodically trigger scheduling of the first station for uplink transmission, and the request message includes information indicating an interval between two adjacent times of triggering of scheduling.

With reference to the second aspect, in some implementations of the second aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

For beneficial effect of the method shown in the second aspect and the possible designs of the second aspect, refer to the beneficial effect in the first aspect and the possible designs of the first aspect.

According to a third aspect, a communication method is provided. The method may be performed by an AP MLD, or may be performed by a component (for example, a chip or a circuit) of an AP MLD. This is not limited. For ease of description, the following uses an example in which the method is performed by the AP MLD for description.

The communication method includes that the AP MLD receives a request message from a first station via a second affiliated AP, where the request message is used to request the second affiliated AP to periodically trigger scheduling of the first station for uplink transmission, and the request message includes information indicating an interval between two adjacent times of triggering of scheduling, and the AP MLD performs data sending/receiving with the first station via the second affiliated AP through a radio frequency transmit/receive chain of the second affiliated AP and a first radio frequency transmit/receive chain of a first affiliated AP, where the first radio frequency transmit/receive chain is all or a part of radio frequency transmit/receive chains of the first affiliated AP.

Based on the foregoing technical solution, after receiving the request message that is from the first station associated with the second affiliated AP and that is used to request to periodically trigger scheduling, the second affiliated AP affiliated to the AP MLD can perform data sending/receiving with the first station through the radio frequency transmit/receive chain of the second affiliated AP and the first radio frequency transmit/receive chain of the first affiliated AP. This increases a transmission rate between the second affiliated AP and a station associated with the second affiliated AP.

With reference to the third aspect, in some implementations of the third aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

With reference to the third aspect, in some implementations of the third aspect, the first radio frequency transmit/receive chain is all of the radio frequency transmit/receive chains of the first affiliated AP. The method further includes that the AP MLD generates first signaling via the second affiliated AP or the first affiliated AP based on the information included in the request message, where the first signaling indicates that no traffic identifier is mapped to a link of the first affiliated AP in a first time period, and the AP MLD sends the first signaling to a non-AP MLD via the first affiliated AP, where the non-AP MLD is a non-AP MLD associated with the first affiliated AP. The first signaling may be signaling (for example, a TID-to-link mapping) indicating a mapping relationship between a traffic identifier and a link, or may be other signaling (for example, 1-bit information).

Based on the foregoing technical solution, an affiliated AP affiliated to the AP MLD generates the first signaling indicating that no traffic identifier is mapped to the link of the first affiliated AP in the first time period, and sends the first signaling to the non-AP MLD associated with the first affiliated AP, to forbid the non-AP MLD from sending data to the first affiliated AP. In addition, the first affiliated AP is not allowed to perform data sending/receiving in the first time period through the radio frequency transmit/receive chain of the first affiliated AP. In this way, the second affiliated AP can perform data sending/receiving through the radio frequency transmit/receive chain of the first affiliated AP.

With reference to the third aspect, in some implementations of the third aspect, the first radio frequency transmit/receive chain is the part of the radio frequency transmit/receive chains of the first affiliated AP. The method further includes that the AP MLD sends third signaling to a non-AP MLD via the first affiliated AP, where the third signaling indicates the non-AP MLD and the first affiliated AP to perform transmission in a first time period through a radio frequency transmit/receive chain other than the first radio frequency transmit/receive chain.

Based on the foregoing technical solution, an affiliated AP affiliated to the AP MLD generates the third signaling indicating that the part of radio frequency transmit/receive chains of the first affiliated AP cannot be used by the first affiliated AP in the first time period, and sends the third signaling to the non-AP MLD associated with the first affiliated AP. In this way, the first affiliated AP is not allowed to perform data sending/receiving in the first time period through the part of the radio frequency transmit/receive chains of the first affiliated AP, therefore the second affiliated AP can perform data sending/receiving through the part of the radio frequency transmit/receive chains of the first affiliated AP, and the first affiliated AP can still perform data sending/receiving in the first time period through the radio frequency transmit/receive chain other than the first radio frequency transmit/receive chain, to serve a station associated with the first affiliated AP.

With reference to the third aspect, in some implementations of the third aspect, that the AP MLD performs data sending/receiving with the first station via the second affiliated AP through a radio frequency transmit/receive chain of the second affiliated AP and a first radio frequency transmit/receive chain of a first affiliated AP includes that the AP MLD performs data sending/receiving with the first station in the first time period via the second affiliated AP through the radio frequency transmit/receive chain of the second affiliated AP and the first radio frequency transmit/receive chain of the first affiliated AP.

Based on the foregoing technical solution, the second affiliated AP can perform data sending/receiving through the first radio frequency transmit/receive chain of the first affiliated AP in a time period in which the first affiliated AP does not use the first radio frequency transmit/receive chain. This avoids a conflict.

With reference to the third aspect, in some implementations of the third aspect, the method further includes that the AP MLD sends second signaling to the first station via the second affiliated AP, where the second signaling indicates the first station to communicate with the second affiliated AP in a time period in which the first station is woken up, where a start time of the time period in which the first station is woken up is a first threshold later than a start time of a corresponding first time period, an end time of the time period in which the first station is woken up is the first threshold earlier than an end time of the corresponding first time period, and a count of time periods in which the first station is woken up is the same as a count of first time periods.

With reference to the third aspect, in some implementations of the third aspect, that the AP MLD performs data sending/receiving with the first station via the second affiliated AP through a radio frequency transmit/receive chain of the second affiliated AP and a first radio frequency transmit/receive chain of a first affiliated AP includes that the AP MLD performs data sending/receiving with the first station via the second affiliated AP through the radio frequency transmit/receive chain of the second affiliated AP and the first radio frequency transmit/receive chain of the first affiliated AP in the time period in which the first station is woken up.

Based on the foregoing technical solution, the second affiliated AP can indicate, using the second signaling, the first station associated with the second affiliated AP to be woken up, in the time period in which the first station is woken up, to communicate with the second affiliated AP. The time period in which the first station is woken up can be the same as a time period in which the mapping relationship takes effect. Alternatively, the start time of the time period in which the first station is woken up is a first threshold later than the start time of the corresponding first time period, and the end time of the time period in which the first station is woken up is the first threshold earlier than the end time of the corresponding first time period. In the time period in which the first station is woken up, the second affiliated AP can perform data sending/receiving through the radio frequency transmit/receive chain of the second affiliated AP, and can also perform data sending/receiving through the radio frequency transmit/receive chain of the first affiliated AP. This increases a transmission rate between the second affiliated AP and a station associated with the second affiliated AP, and the first station can be in a power-saving mode at a time without the time period in which the first station is woken up.

According to a fourth aspect, a communication method is provided. The method may be performed by a first station, or may be performed by a component (for example, a chip or a circuit) of a first station. This is not limited. For ease of description, the following uses an example in which the method is performed by the first station for description. The first station may be a single-link non-AP, or may be a non-AP MLD. This is not limited in this disclosure.

The communication method includes that the first station associated with a second affiliated AP affiliated to an AP MLD sends a request message to the second affiliated AP, where the request message is used to request the second affiliated AP to periodically trigger scheduling of the first station for uplink transmission, and the request message includes information indicating an interval between two adjacent times of triggering of scheduling, and the first station and the second affiliated AP perform data sending/receiving through a radio frequency transmit/receive chain of the second affiliated AP and a first radio frequency transmit/receive chain of a first affiliated AP.

With reference to the fourth aspect, in some implementations of the fourth aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

With reference to the fourth aspect, in some implementations of the fourth aspect, that the first station and the second affiliated AP perform data sending/receiving through a radio frequency transmit/receive chain of the second affiliated AP and a first radio frequency transmit/receive chain of a first affiliated AP includes that the first station and the second affiliated AP perform data sending/receiving in a first time period through the radio frequency transmit/receive chain of the second affiliated AP and the first radio frequency transmit/receive chain of the first affiliated AP, where the first affiliated AP does not perform data sending/receiving in the first time period through the first radio frequency transmit/receive chain of the first affiliated AP.

With reference to the fourth aspect, in some implementations of the fourth aspect, the method further includes that the first station receives second signaling from the second affiliated AP, where the second signaling indicates the first station to communicate with the second affiliated AP in a time period in which the first station is woken up, where a start time of the time period in which the first station is woken up is a first threshold later than a start time of a corresponding first time period, an end time of the time period in which the first station is woken up is the first threshold earlier than an end time of the corresponding first time period, and a count of time periods in which the first station is woken up is the same as a count of first time periods.

With reference to the fourth aspect, in some implementations of the fourth aspect, that the first station and the second affiliated AP perform data sending/receiving through a radio frequency transmit/receive chain of the second affiliated AP and a first radio frequency transmit/receive chain of a first affiliated AP includes that the first station and the second affiliated AP perform data sending/receiving through the radio frequency transmit/receive chain of the second affiliated AP and the first radio frequency transmit/receive chain of the first affiliated AP in the time period in which the first station is woken up.

For beneficial effect of the method shown in the fourth aspect and the possible designs of the fourth aspect, refer to the beneficial effect in the third aspect and the possible designs of the third aspect.

According to a fifth aspect, an AP MLD is provided. The AP MLD is configured to perform the method provided in the first aspect.

The AP MLD includes a processing unit configured to generate first signaling via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively, and a sending unit configured to send, via the affiliated AP, the first signaling to a non-AP MLD associated with the AP MLD.

With reference to the fifth aspect, in some implementations of the fifth aspect, the first signaling further includes fourth indication information. The fourth indication information indicates a count of times that the mapping relationship takes effect. The count of times that the mapping relationship takes effect is greater than 1.

With reference to the fifth aspect, in some implementations of the fifth aspect, that the sending unit sends, via the affiliated AP, the first signaling to the non-AP MLD associated with the AP MLD includes that the sending unit sends, via the affiliated AP, a beacon frame to the non-AP MLD associated with the AP MLD, where the beacon frame includes the first signaling.

With reference to the fifth aspect, in some implementations of the fifth aspect, that the first signaling indicates a mapping relationship between a traffic identifier and a link includes that the first signaling indicates that no traffic identifier is mapped to a link of a first affiliated AP in a time period in which the mapping relationship takes effect. The processing unit is further configured to perform data sending/receiving via a second affiliated AP through radio frequency transmit/receive chains of the first affiliated AP and the second affiliated AP in the time period in which the mapping relationship takes effect.

With reference to the fifth aspect, in some implementations of the fifth aspect, that the first signaling indicates a mapping relationship between a traffic identifier and a link includes that the first signaling indicates that no traffic identifier is mapped to a link of a first affiliated AP in a time period in which the mapping relationship takes effect. The sending unit is further configured to send second signaling to a first station via a second affiliated AP, where the second signaling indicates the first station to communicate with the second affiliated AP in a time period in which the first station is woken up. The processing unit is further configured to perform data sending/receiving via the second affiliated AP through radio frequency transmit/receive chains of the first affiliated AP and the second affiliated AP in the time period in which the first station is woken up, where the first station is a station associated with the second affiliated AP, a start time of the time period in which the first station is woken up is a first threshold later than a start time of a corresponding time period in which the mapping relationship takes effect, an end time of the time period in which the first station is woken up is the first threshold earlier than an end time of the corresponding time period in which the mapping relationship takes effect, and a count of time periods in which the first station is woken up is the same as a count of time periods in which the mapping relationship takes effect.

With reference to the fifth aspect, in some implementations of the fifth aspect, the AP MLD further includes a receiving unit configured to receive a request message from the first station via the second affiliated AP, where the request message is used to request the second affiliated AP to periodically trigger scheduling of the first station for uplink transmission, and the request message includes information indicating an interval between two adjacent times of triggering of scheduling.

With reference to the fifth aspect, in some implementations of the fifth aspect, the request message further includes at least one of the following information: information indicating a start time for triggering scheduling, a service time for triggering scheduling each time, information used to determine a service time for triggering scheduling each time, information indicating an access policy, information for requesting a long-range transmission mode service, or information used to determine whether to use a long-range transmission mode service.

With reference to the fifth aspect, in some implementations of the fifth aspect, that the processing unit generates the first signaling via the affiliated AP affiliated to the AP MLD includes that the processing unit generates, via the affiliated AP, the first signaling based on the information included in the request message.

For beneficial effect of the method shown in the fifth aspect and the possible designs of the fifth aspect, refer to the beneficial effect in the first aspect and the possible designs of the first aspect.

According to a sixth aspect, a non-AP MLD is provided. The non-AP MLD is configured to perform the method provided in the second aspect.

The non-AP MLD includes a receiving unit configured to receive first signaling sent by an AP MLD associated with the non-AP MLD via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively, and a processing unit configured to determine a transmission link for data traffic based on the first signaling.

With reference to the sixth aspect, in some implementations of the sixth aspect, the first signaling further includes fourth indication information. The fourth indication information indicates a count of times that the mapping relationship takes effect. The count of times that the mapping relationship takes effect is greater than 1.

With reference to the sixth aspect, in some implementations of the sixth aspect, that the receiving unit receives the first signaling sent by the AP MLD via the affiliated AP affiliated to the AP MLD includes that the receiving unit receives a beacon frame sent by the AP MLD via the affiliated AP affiliated to the AP MLD, where the beacon frame includes the first signaling.

With reference to the sixth aspect, in some implementations of the sixth aspect, that the first signaling indicates a mapping relationship between a traffic identifier and a link includes that the first signaling indicates that no traffic identifier is mapped to a link of a first affiliated AP in a time period in which the mapping relationship takes effect. The receiving unit is further configured to receive second signaling from a second affiliated AP, where the second signaling indicates a first station to communicate with the second affiliated AP in a time period in which the first station is woken up, where the first station is a station associated with the second affiliated AP, a start time of the time period in which the first station is woken up is a first threshold later than a start time of a corresponding time period in which the mapping relationship takes effect, an end time of the time period in which the first station is woken up is the first threshold earlier than an end time of the corresponding time period in which the mapping relationship takes effect, and a count of time periods in which the first station is woken up is the same as a count of time periods in which the mapping relationship takes effect.

With reference to the sixth aspect, in some implementations of the sixth aspect, the non-AP MLD further includes a sending unit configured to send a request message to the second affiliated AP, where the request message is used to request the second affiliated AP to periodically trigger scheduling of the first station for uplink transmission, and the request message includes information indicating an interval between two adjacent times of triggering of scheduling.

With reference to the sixth aspect, in some implementations of the sixth aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

For beneficial effect of the method shown in the sixth aspect and the possible designs of the sixth aspect, refer to the beneficial effect in the second aspect and the possible designs of the second aspect.

According to a seventh aspect, an AP MLD is provided. The AP MLD is configured to perform the method provided in the third aspect.

The AP MLD includes a receiving unit configured to receive a request message from a first station via a second affiliated AP, where the request message is used to request the second affiliated AP to periodically trigger scheduling of the first station for uplink transmission, and the request message includes information indicating an interval between two adjacent times of triggering of scheduling, and a processing unit configured to perform data sending/receiving with the first station via the second affiliated AP through a radio frequency transmit/receive chain of the second affiliated AP and a first radio frequency transmit/receive chain of a first affiliated AP, where the first radio frequency transmit/receive chain is all or a part of radio frequency transmit/receive chains of the first affiliated AP.

With reference to the seventh aspect, in some implementations of the seventh aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

With reference to the seventh aspect, in some implementations of the seventh aspect, the first radio frequency transmit/receive chain is all of the radio frequency transmit/receive chains of the first affiliated AP. The processing unit is further configured to generate first signaling via the second affiliated AP or the first affiliated AP based on the information included in the request message, where the first signaling indicates that no traffic identifier is mapped to a link of the first affiliated AP in a first time period, and the AP MLD sends the first signaling to a non-AP MLD via the first affiliated AP, where the non-AP MLD is a non-AP MLD associated with the first affiliated AP. The first signaling may be signaling (for example, a TID-to-link mapping) indicating a mapping relationship between a traffic identifier and a link, or may be other signaling (for example, 1-bit information).

With reference to the seventh aspect, in some implementations of the seventh aspect, the first radio frequency transmit/receive chain is the part of the radio frequency transmit/receive chains of the first affiliated AP. The AP MLD further includes a sending unit configured to send third signaling to a non-AP MLD via the first affiliated AP, where the third signaling indicates the non-AP MLD to perform transmission in a first time period through a radio frequency transmit/receive chain other than the first radio frequency transmit/receive chain.

With reference to the seventh aspect, in some implementations of the seventh aspect, that the processing unit performs data sending/receiving with the first station via the second affiliated AP through the radio frequency transmit/receive chain of the second affiliated AP and the first radio frequency transmit/receive chain of the first affiliated AP includes that the processing unit performs data sending/receiving with the first station in the first time period via the second affiliated AP through the radio frequency transmit/receive chain of the second affiliated AP and the first radio frequency transmit/receive chain of the first affiliated AP.

With reference to the seventh aspect, in some implementations of the seventh aspect, the sending unit is further configured to send second signaling to the first station via the second affiliated AP, where the second signaling indicates the first station to communicate with the second affiliated AP in a time period in which the first station is woken up, where a start time of the time period in which the first station is woken up is a first threshold later than a start time of a corresponding first time period, an end time of the time period in which the first station is woken up is the first threshold earlier than an end time of the corresponding first time period, and a count of time periods in which the first station is woken up is the same as a count of first time periods.

With reference to the seventh aspect, in some implementations of the seventh aspect, that the processing unit performs data sending/receiving with the first station via the second affiliated AP through the radio frequency transmit/receive chain of the second affiliated AP and the first radio frequency transmit/receive chain of the first affiliated AP includes that the processing unit performs data sending/receiving with the first station via the second affiliated AP through the radio frequency transmit/receive chain of the second affiliated AP and the first radio frequency transmit/receive chain of the first affiliated AP in the time period in which the first station is woken up.

For beneficial effect of the method shown in the seven aspect and the possible designs of the seventh aspect, refer to the beneficial effect in the third aspect and the possible designs of the third aspect.

According to an eighth aspect, a first station is provided. The first station is configured to perform the method provided in the fourth aspect.

The first station includes a sending unit configured to send a request message to a second affiliated AP associated with the first station, where the request message is used to request the second affiliated AP to periodically trigger scheduling of the first station for uplink transmission, and the request message includes information indicating an interval between two adjacent times of triggering of scheduling, and a processing unit configured to perform data sending/receiving with the second affiliated AP through a radio frequency transmit/receive chain of the second affiliated AP and a first radio frequency transmit/receive chain of a first affiliated AP.

With reference to the eighth aspect, in some implementations of the eighth aspect, the request message further includes at least one of the following information: information indicating a start time for triggering scheduling, information indicating a service time for triggering scheduling each time, information used to determine a service time for triggering scheduling each time, information indicating an access policy, information for requesting a long-range transmission mode service, or information used to determine whether to use a long-range transmission mode service.

With reference to the eighth aspect, in some implementations of the eighth aspect, that the processing unit and the second affiliated AP perform data sending/receiving through the radio frequency transmit/receive chain of the second affiliated AP and the first radio frequency transmit/receive chain of the first affiliated AP includes that the processing unit and the second affiliated AP perform data sending/receiving in a first time period through the radio frequency transmit/receive chain of the second affiliated AP and the first radio frequency transmit/receive chain of the first affiliated AP, where the first affiliated AP does not perform data sending/receiving in the first time period through the first radio frequency transmit/receive chain of the first affiliated AP.

With reference to the eighth aspect, in some implementations of the eighth aspect, the first station further includes a receiving unit configured to receive second signaling from the second affiliated AP, where the second signaling indicates the first station to communicate with the second affiliated AP in a time period in which the first station is woken up, where a start time of the time period in which the first station is woken up is a first threshold later than a start time of a corresponding first time period, an end time of the time period in which the first station is woken up is the first threshold earlier than an end time of the corresponding first time period, and a count of time periods in which the first station is woken up is the same as a count of first time periods.

With reference to the eighth aspect, in some implementations of the eighth aspect, that the processing unit and the second affiliated AP perform data sending/receiving through the radio frequency transmit/receive chain of the second affiliated AP and the first radio frequency transmit/receive chain of the first affiliated AP includes that the processing unit and the second affiliated AP perform data sending/receiving through the radio frequency transmit/receive chain of the second affiliated AP and the first radio frequency transmit/receive chain of the first affiliated AP in the time period in which the first station is woken up.

For beneficial effect of the method shown in the eighth aspect and the possible designs of the eighth aspect, refer to the beneficial effect in the fourth aspect and the possible designs of the fourth aspect.

According to a ninth aspect, a communication apparatus is provided. The apparatus is configured to perform the method provided in the first aspect or the third aspect. Further, the communication apparatus may include units and/or modules, for example, a processing unit and a transceiver unit configured to perform the method provided in any one of the foregoing implementations of the first aspect or the third aspect.

In an implementation, when the communication apparatus is an AP MLD, the transceiver unit may be a transceiver or an input/output interface, and the processing unit may be at least one processor. Optionally, the transceiver may be a transceiver circuit. Optionally, the input/output interface may be an input/output circuit.

In another implementation, when the communication apparatus is a chip, a chip system, or a circuit in an AP MLD, the transceiver unit may be an input/output interface, an interface circuit, an output circuit, an input circuit, a pin, a related circuit, or the like on the chip, the chip system, or the circuit. The processing unit may be at least one processor, a processing circuit, a logic circuit, or the like.

According to a tenth aspect, a communication apparatus is provided. The apparatus is configured to perform the method provided in the second aspect or the fourth aspect. Further, the communication apparatus may include units and/or modules, for example, a processing unit and a transceiver unit configured to perform the method provided in the second aspect or the fourth aspect.

In an implementation, when the communication apparatus is a non-AP MLD, the transceiver unit may be a transceiver or an input/output interface, and the processing unit may be at least one processor. Optionally, the transceiver may be a transceiver circuit. Optionally, the input/output interface may be an input/output circuit.

In another implementation, when the communication apparatus is a chip, a chip system, or a circuit in a non-AP MLD, the transceiver unit may be an input/output interface, an interface circuit, an output circuit, an input circuit, a pin, a related circuit, or the like on the chip, the chip system, or the circuit. The processing unit may be at least one processor, a processing circuit, a logic circuit, or the like.

According to an eleventh aspect, this disclosure provides a processor configured to perform the methods provided in the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this disclosure.

According to a twelfth aspect, a computer-readable storage medium is provided. The computer-readable storage medium stores program code to be executed by a device. The program code includes instructions used to perform the method provided in any one implementation of the first aspect to the fourth aspect.

According to a thirteenth aspect, a computer program product including instructions is provided. When the computer program product runs on a computer, the computer is enabled to perform the method provided in any implementations of the first aspect to the fourth aspect.

According to a fourteenth aspect, a chip is provided. The chip includes a processor and a communication interface. The processor reads, through the communication interface, instructions stored in a memory, to perform the method provided in any implementation of the first aspect to the fourth aspect.

Optionally, in an implementation, the chip further includes a memory. The memory stores a computer program or instructions. The processor is configured to execute the computer program or the instructions stored in the memory. When the computer program or the instructions are executed, the processor is configured to perform the method provided in any implementation of the first aspect to the fourth aspect.

According to a fifteenth aspect, a communication system is provided, including the AP MLD according to the fifth aspect and the non-AP MLD according to the sixth aspect.

### BRIEF DESCRIPTION OF DRAWINGS

FIG. 1 is a diagram of a communication system to which a communication method is applicable according to an embodiment of this disclosure;

FIG. 2 is a diagram of an internal structure of an AP;

FIG. 3 is a diagram of an internal structure of a station;

FIG. 4 is a diagram of an MLD;

FIG. 5 is a diagram of setting up a link between an AP MLD and a non-AP MLD;

FIG. 6 is a diagram of a target wake time (TWT) service period according to an embodiment of this disclosure;

FIG. 7 is a diagram of a broadcast TWT according to an embodiment of this disclosure;

FIG. 8 is a diagram of a TID-to-link mapping element according to an embodiment of this disclosure;

FIG. 9 is a diagram of a stream classification service (SCS) request frame according to an embodiment of this disclosure;

FIG. 10 is a diagram of an SCS descriptor according to an embodiment of this disclosure;

FIG. 11 is a diagram of an intra-access category priority element according to an embodiment of this disclosure;

FIG. 12 is a diagram of a QoS characteristics element according to an embodiment of this disclosure;

FIG. 13 is a diagram of an SCS response frame according to an embodiment of this disclosure;

FIG. 14 is a schematic flowchart of a communication method according to an embodiment of this disclosure;

FIG. 15 is a schematic flowchart of another communication method according to an embodiment of this disclosure;

FIG. 16 is a diagram of a long-range transmission scenario according to an embodiment of this disclosure;

FIG. 17 is a diagram of a correspondence between a restricted TWT (rTWT) and link disablement according to an embodiment of this disclosure;

FIG. 18 is a diagram of a correspondence between an rTWT and a TWT #1 according to an embodiment of this disclosure;

FIG. 19 is a block diagram of an apparatus 1900 according to an embodiment of this disclosure; and

FIG. 20 is a block diagram of an apparatus 2000 according to an embodiment of this disclosure.

### DESCRIPTION OF EMBODIMENTS

The following describes the technical solutions in embodiments of this disclosure with reference to the accompanying drawings.

The technical solutions in embodiments of this disclosure may be applied to various communication systems, for example, a WLAN communication system or a future communication system.

As example descriptions, the following describes an application scenario in embodiments of this disclosure and a method in embodiments of this disclosure by using a WLAN system as an example.

Further, embodiments of this disclosure may be applied to a WLAN, and embodiments of this disclosure is applicable to any protocol in The Institute of Electrical and Electronics Engineers (IEEE) 802.11 series protocols used in the WLAN. The WLAN may include one or more basic service sets (BSSs), and network nodes of the BSS include an AP and a station (STA). Each BSS may include one AP and multiple STAs associated with the AP.

In embodiments of this disclosure, a transmit end and/or receive end may be a user STA in the WLAN. The user station may also be referred to as a system, a subscriber unit, an access terminal, a mobile station, a remote station, a remote terminal, a mobile device, a user terminal, a terminal, a wireless communication device, a user agent, a user apparatus, or user equipment (UE). The STA may be a cellular phone, a cordless phone, a Session Initiation Protocol (SIP) phone, a wireless local loop (WLL) station, a personal digital assistant (PDA), a handheld device having a WLAN (for example, WI-FI) communication function, a wearable device, a computing device, or another processing device connected to a wireless modem.

In addition, the transmit end and/or the receive end in embodiments of this disclosure may alternatively be an AP in the WLAN. The AP may be configured to communicate with an access terminal through the wireless local area network, and transmit data of the access terminal to a network side, or transmit data from a network side to the access terminal.

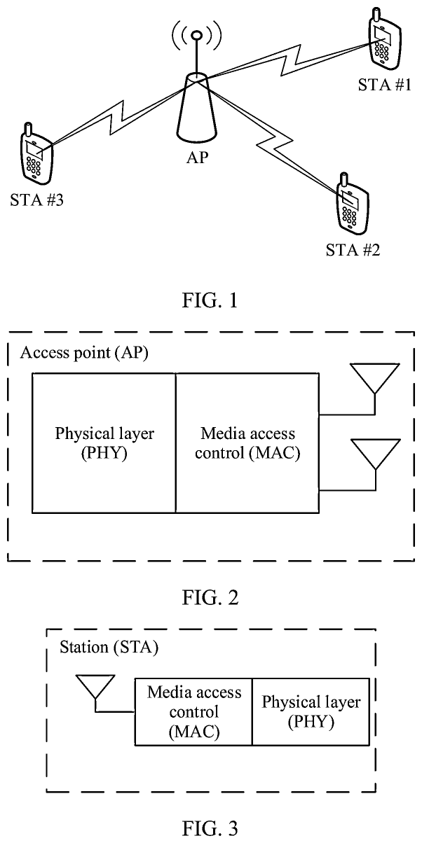

For ease of understanding embodiments of this disclosure, a communication system shown in FIG. 1 is first used as an example to describe in detail a communication system applicable to embodiments of this disclosure. The communication system shown in FIG. 1 may be a WLAN system. The WLAN system in FIG. 1 may include one or more APs and one or more STAs. In FIG. 1, communication between one AP (the AP shown in FIG. 1) and three STAs (a STA #1, a STA #2, and a STA #3 shown in FIG. 1) is used as an example.

Wireless communication may be performed between the AP and the STA using various standards. For example, a manner of uplink transmission between the AP and the STA includes but is not limited to an orthogonal frequency-division multiple access (OFDMA) manner, a multi-user multiple-input multiple-output (MU-MIMO) manner, an OFDMA and MU-MIMO hybrid transmission manner, or a single-user multiple-input multiple-output (SU-MIMO) technology.

The AP is also referred to as a wireless AP, a hotspot, or the like. The AP is an AP for a mobile user to access a wired network, and is mainly deployed in a home, a building, or a campus, or may be deployed outdoors. The AP is equivalent to a bridge that connects the wired network and a wireless network. A main function of the AP is to connect wireless network clients together, and then connect the wireless network to the ethernet. Further, the AP may be a terminal device or a network device with a WI-FI chip. Optionally, the AP may be a device that supports multiple WLAN standards such as 802.11.

FIG. 2 is a diagram of an internal structure of the AP. The AP may have multiple antennas or may have a single antenna. In FIG. 2, the AP includes a physical layer (PHY) processing circuit and a media access control (MAC) processing circuit. The physical layer processing circuit may be configured to process a physical layer signal, and the MAC layer processing circuit may be configured to process a MAC layer signal.

A STA product is usually a terminal product that supports 802.11 series standards, for example, a mobile phone or a notebook computer. FIG. 3 is a diagram of a structure of the STA with a single antenna. In an actual scenario, the STA may alternatively have multiple antennas, and may be a device with more than two antennas. In FIG. 3, the STA may include a PHY processing circuit and a MAC processing circuit. The physical layer processing circuit may be configured to process a physical layer signal, and the MAC layer processing circuit may be configured to process a MAC layer signal.

It should be noted that FIG. 2 and FIG. 3 are merely simple diagrams, and do not constitute any limitation on the protection scope of this disclosure. For internal structures of the AP and the STA, refer to descriptions of another technology, or refer to internal structures of the AP and the STA after future technology development. The internal structures of the AP and the STA are not limited in this disclosure. Details are not described again either.

For ease of understanding embodiments of this disclosure, several basic concepts in embodiments of this disclosure are briefly described. It should be understood that the basic concepts described below are briefly described by using a basic concept specified in a WLAN protocol as an example, but embodiments of this disclosure are not limited to being applied only to a WLAN system. Therefore, standard names appearing when the WLAN system is used as an example for description are all functional descriptions, and specific names are not limited, indicate only functions of a device, and may be correspondingly expanded to another system, for example, an NR system or a future communication system.

### 1. Multiple Links:

Due to an increasingly high user requirement on communication quality of service, it is difficult for an IEEE 802.11ax standard to meet user requirements in terms of a high throughput, a low jitter, a low delay, and the like. Therefore, a next-generation IEEE technology, for example, an IEEE 802.11be standard, urgently needs to be developed.

A device in an IEEE 802.11 next-generation standard needs to be backward compatible, that is, compatible with the IEEE 802.11ax standard and an earlier standard. Therefore, the device in the IEEE 802.11 next-generation standard also supports an operating frequency band of a device in IEEE 802.11ax. For example, the device in the IEEE 802.11 next-generation standard supports frequency bands such as 2.4 gigahertz (GHz), 5 GHZ, and 6 GHz.

Further, channel division may be performed based on a latest open free 6 GHz frequency band, so that a supported bandwidth may exceed a maximum bandwidth 160 megahertz (MHz) (for example, 320 MHz) supported in 5 GHz. In a same frequency band, a peak throughput may be improved and a traffic transmission delay may be reduced in a manner like cooperation of multiple channels. In addition to an ultra-large bandwidth, a device in an IEEE 802.11ax next-generation standard may further improve the peak throughput in a manner like cooperation of multiple frequency bands (2.4 GHz, 5 GHZ, and 6 GHZ). In this disclosure, the multiple frequency bands or the multiple channels are collectively referred to as the multiple links.

### 2. MLD:

In embodiments of this disclosure, a next-generation IEEE 802.11 standard device that supports multiple links at the same time is referred to as the MLD.

The MLD means that the device has multiple radio frequency modules at the same time that operate in different frequency bands (or on different channels). Each affiliated device (for example, an affiliated AP or an affiliated STA) of each MLD has a MAC address, the MLD further has an MLD MAC address. For ease of distinguishing, the MAC address of the affiliated device may be referred to as a low MAC address, and the MLD MAC address may be referred to as a high MAC address.

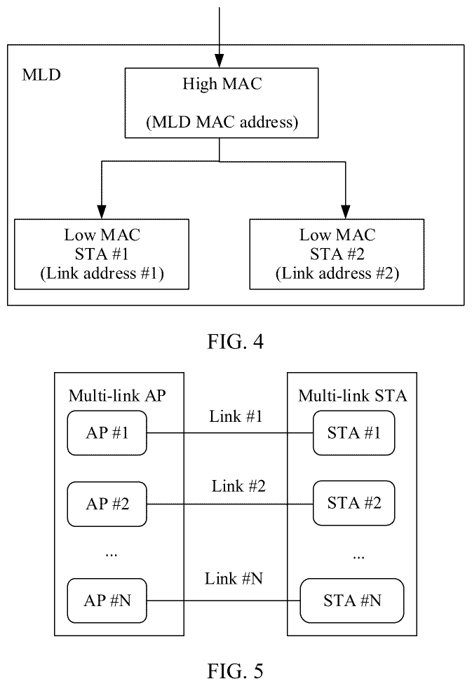

For ease of understanding, the following briefly describes a structure of the MLD with reference to FIG. 4. In FIG. 4, an example in which the MLD is a STA MLD and includes two STAs is used for description. FIG. 4 is a diagram of the MLD.

Optionally, the MLD may be an AP MLD, or may be a non-AP MLD, for example, the STA MLD. It should be noted that names of the foregoing MLDs are merely examples, and do not constitute any limitation on the protection scope of this disclosure. For example, the AP MLD may also be referred to as a multi-link AP. Alternatively, with development of a communication technology, the AP MLD may have other names. Examples are not provided one by one for description herein.

For example, each of two MLDs (for example, two non-AP MLDs) includes multiple STAs, where each STA in one MLD may set up a link to one STA in the other MLD for communication.

Alternatively, for example, each of two MLDs (for example, two AP MLDs) includes multiple APs, where each AP in one MLD may set up a link to one AP in the other MLD for communication.

Alternatively, for example, one MLD (for example, a non-AP MLD) in two MLDs includes multiple STAs, and the other MLD (for example, an AP MLD) includes multiple Aps, where each STA in the MLD may set up a link to one AP in the other MLD for communication.

The MLD operates in all or some of frequency bands: 1 GHZ, 2.4 GHZ, 5 GHZ, 6 GHZ, and a high frequency of 60 GHz. FIG. 5 is a diagram of setting up a link between the AP MLD and the non-AP MLD.

It can be learned from FIG. 5 that the AP MLD includes N AP entities (an AP #1, an AP #2, . . . , and an AP #N shown in FIG. 5). The non-AP MLD includes N STA entities (a STA #1, a STA #2, . . . , and a STA #N shown in FIG. 5). The N STA entities may share a MAC layer.

Further, the AP #1 in the AP MLD communicates with the STA #1 in the non-AP MLD through a link (a link #1 shown in FIG. 5). The AP #2 in the AP MLD communicates with the STA #2 in the non-AP MLD through a link (a link #2 shown in FIG. 5). The AP #N in the AP MLD communicates with the STA #N in the non-AP MLD through a link (a link #N shown in FIG. 5).

3. Enhanced Multi-Link Single Radio (eMLSR) and Enhanced Multi-Link Multiple Radio (eMLMR) Operation Modes:

IEEE 802.11be defines two operation modes for the non-AP MLD: eMLSR and eMLMR. A non-AP MLD supporting eMLSR performs data transmission on one link, and performs listening on multiple links at the same time. After a non-AP MLD supporting eMLSR receives a specific trigger frame sent by the AP MLD on a link, the non-AP MLD switches a radio frequency transmit/receive (Tx/Rx) chain on another link to a channel on which the link on which the specific trigger frame is received is located, to perform data sending/receiving, so as to increase a throughput and receiving reliability, and prevent downlink data transmission from being blocked because the link is busy.

A non-AP MLD supporting eMLMR may perform data transmission on multiple links at the same time. For a link operating in an eMLMR mode, similarly, if the non-AP MLD receives a specific trigger frame sent by the AP MLD on a link, the non-AP MLD may switch a Tx/Rx chain of the link operating in the eMLMR mode to a channel on which the link on which the specific trigger frame is received is located, to perform data sending/receiving, so as to increase a throughput and receiving reliability, and prevent downlink data transmission from being blocked because the link is busy.

The AP MLD in embodiments of this disclosure may support the eMLMR mode. For example, after the AP MLD receives a request message on a link, the AP MLD may switch a Tx/Rx chain of an unused link to a channel on which the link on which the request message is received is located, to perform data sending/receiving, so as to increase a throughput and receiving reliability, and prevent uplink data transmission from being blocked because the link is busy. How the AP MLD supports the eMLMR mode is described below with reference to a specific embodiment. Details are not described herein.

### 4. TWT:

The TWT is a technology for power saving defined in WI-FI. A core idea is to set some periodic time periods (or service periods (SPs)), so that some devices need to keep active only in these time periods, and may sleep in another time period, to save power. The TWT is classified into an individual TWT and a broadcast TWT. In the individual TWT, each STA may separately set up a TWT agreement with an AP. Therefore, each STA may have an active time period and a sleep time period of the STA. In the broadcast TWT, an AP may set up a public TWT agreement for a group of STAs, and multiple STAs operate in a same active time period and sleep in another time period.

Usually, the STA sends a TWT agreement setup request to the AP. To be specific, the STA is a TWT requesting STA (for ease of description, the TWT requesting station may be referred to as a requesting station below), and the AP is a TWT responding STA (for ease of description, the TWT responding station may be referred to as a responding station below). Certainly, the AP may alternatively initiate a TWT agreement setup request to the station. For ease of description, in the following, the STA is a requesting station, and the AP is a responding station.

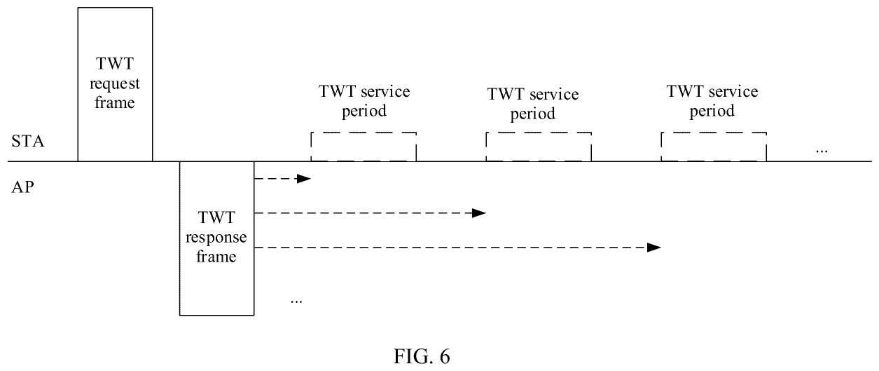

After the TWT agreement is set up, an agreed-on active time period is referred to as a TWT service period (Service Period, SP). Each TWT agreement may include multiple equal-length TWT service periods that periodically appear. As shown in FIG. 6, FIG. 6 is a diagram of the TWT service period according to an embodiment of this disclosure.

### 5. Individual TWT:

The individual TWT means that a requesting station sends a TWT request message to a responding station, to request to set a wake time, after receiving the TWT request message, the responding station sends a TWT response message to the requesting station, and after interaction succeeds, a TWT agreement is set up between the requesting station and the responding station.

After the TWT agreement is agreed on, both the requesting station and the responding station should keep active in an agreed-on time period, to perform data sending/receiving. Without the time period, the stations may sleep to save power.

### 6. Broadcast TWT:

The broadcast TWT provides a “batch management” mechanism. An AP may set up, with multiple STAs, a series of TWT service periods that periodically appear. In the service periods, the multiple STAs need to keep active to communicate with the AP.

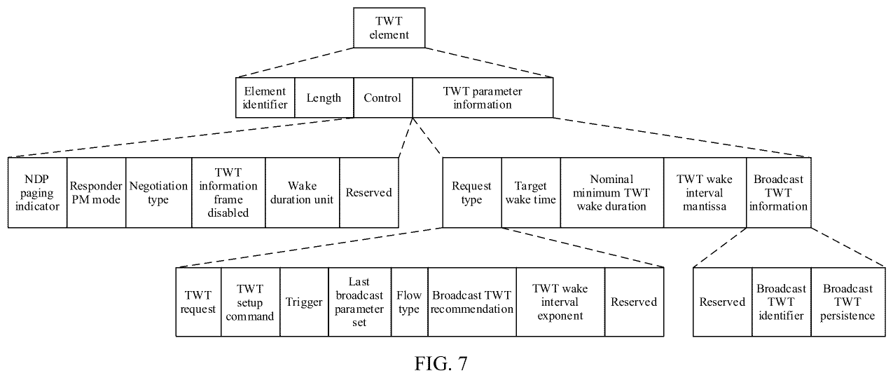

The AP may include information about one or more broadcast TWTs in a beacon frame. Each broadcast TWT is jointly represented by a broadcast TWT identifier and a MAC address of the AP. For ease of understanding, the broadcast TWT is briefly described with reference to FIG. 7. FIG. 7 is a diagram of the broadcast TWT according to an embodiment of this disclosure.

It can be learned from FIG. 7 that the broadcast TWT may be referred to as a TWT element, and the TWT element includes the following information: an element identifier (ID), a length, control, and TWT parameter information.

Further, the control field includes the following fields: a Neighbor Discovery Protocol (NDP) paging indicator, a responder priority mode (PM) mode, a negotiation type, TWT information frame disabled, a wake duration unit, and reserved.

The TWT parameter information includes the following fields: a request type, a target wake time, nominal minimum TWT wake duration, a TWT wake interval mantissa, and broadcast TWT information. The request type includes a TWT request, a TWT setup command, trigger, a last broadcast parameter set, a flow type, a broadcast TWT recommendation, a TWT wake interval exponent, and reserved. The broadcast TWT information includes reserved, a broadcast TWT ID, and broadcast TWT persistence.

It should be noted that, in embodiments of this disclosure, meanings of the fields included in the TWT element are not described in detail. For details, refer to definitions in a current protocol. Details are not described herein again.

After receiving the beacon frame, if the STA intends to join the broadcast TWT, the STA may send a broadcast TWT setup request message to the AP, to join the broadcast TWT. During setup of the broadcast TWT, the STA needs to specify a broadcast TWT identifier to request to join a specific broadcast TWT. After joining the broadcast TWT, the STA may be woken up based on a service period indicated by a TWT parameter set, to communicate with the AP. It should be noted that, if the STA supports the broadcast TWT but does not explicitly add a broadcast TWT ID, the STA joins a broadcast TWT whose broadcast TWT ID=0 by default.

Similar to that of the individual TWT, a parameter set of the broadcast TWT also specifies a periodicity in which the TWT service period appears and duration of each TWT service period. In addition, a parameter of the broadcast TWT further includes a life cycle of the broadcast TWT. The life cycle is in a unit of a beacon frame interval, and indicates duration of the set-up broadcast TWT.

7. rTWT:

In IEEE 802.11be, a new type of broadcast TWT is defined for low-delay traffic based on a broadcast TWT, and is referred to as the rTWT. For channel access of a STA during a TWT SP, it is defined in the protocol that a TWT element includes a trigger field. When the trigger field is set to 1, the STA cannot initiate enhanced distributed channel access (EDCA) channel access, and can only wait for an AP to send a trigger frame to schedule an access mode.

8. TID-to-link mapping:

When a non-AP MLD is associated with an AP MLD, because there are multiple links, the AP MLD and the non-AP MLD negotiate with each other, to map different TID data traffic to different links based on TIDs, so as to provide differentiated quality of service (QOS).

Alternatively, the AP MLD may broadcast the TID-to-link mapping for all associated non-AP MLDs. When no TID is mapped to a link of the non-AP MLD, the link is disabled. To be specific, the non-AP MLD is not allowed to transmit any frame (including a data frame, a management frame, and a control frame) on the link.

If the AP MLD broadcasts a TID-to-link mapping element and disables a link, all non-AP MLDs that have set up the link cannot transmit any frame (including a data frame, a management frame, and a control frame) on the link, and the AP MLD cannot transmit any frame (including a data frame, a management frame, and a control frame) on the link either.

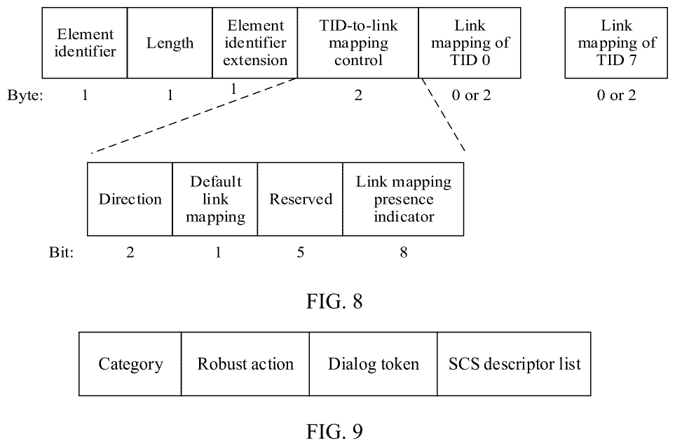

For ease of understanding, the TID-to-link mapping element is described with reference to FIG. 8. FIG. 8 is a diagram of the TID-to-link mapping element according to an embodiment of this disclosure.

It can be learned from FIG. 8 that the TID-to-link mapping element includes the following information: an element ID, a length, element ID extension, and TID-to-link mapping control, and optionally, a link mapping of TID 0 and a link mapping of TID 7. TID-to-link mapping control includes a direction, a default link mapping, reserved, and a link mapping presence indicator.

Further, meanings of the fields included in TID-to-link mapping control are as follows.

The direction field indicates a downlink when being set to 0, indicates an uplink when being set to 1, indicates an uplink and a downlink when being set to 2, or indicates a reserved value when being set to 3.

The default link mapping indicates a default mapping when being set to 1, that is, each TID is mapped to all links.

For the link mapping presence indicator, an n^{th} bit indicates whether a link mapping of TID #n field corresponding to a TID #n is present.

The link mapping of TID #n indicates whether to map the TID #n to a corresponding link. When a corresponding bit is set to 1, it indicates that the TID #n is mapped to the corresponding link.

### 9. Scs Mechanism:

A low delay is an important feature of IEEE 802.11be. A STA may report a low-delay traffic stream to an AP using the SCS mechanism. Further, the STA may report the low-delay traffic stream by sending an SCS request frame to the associated AP, and indicate a corresponding QoS parameter.

For ease of understanding, the SCS request frame is briefly described with reference to FIG. 9. FIG. 9 is a diagram of the SCS request frame according to an embodiment of this disclosure.

It can be learned from FIG. 9 that the SCS request frame includes the following fields: a category, a robust action, a dialog token, and an SCS descriptor list.

Further, meanings of the fields included in the SCS request frame are as follows.

The category indicates a category to which the action frame belongs.

The robust action indicates a frame in the category.

The dialog token is a dialog token.

The SCS descriptor list includes one or more SCS descriptors.

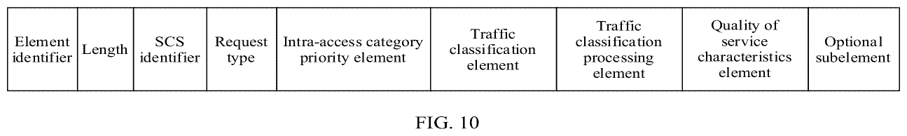

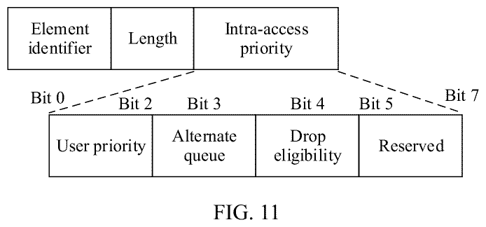

A format of the SCS descriptor is shown in FIG. 10. FIG. 10 is a diagram of the SCS descriptor according to an embodiment of this disclosure.

It can be learned from FIG. 10 that the SCS descriptor includes the following fields: an element ID, a length, an SCS ID, a request type, an intra-access category priority element, a traffic classification (TCLAS) element, a TCLAS processing element, a QoS characteristics element, and an optional subelement, where the intra-access category priority element, the traffic classification element, the traffic classification processing element, and the quality of service characteristics element are optional.

Further, meanings of the fields included in the SCS descriptor are as follows.

The SCS ID (1 byte) indicates an identifier allocated to an SCS stream.

The request type (1 byte) indicates a type of a request, which may be add (0), remove (1), or change (2).

A specific format of the intra-access category priority element is shown in FIG. 11. The intra-access category priority element is described below with reference to FIG. 11. Details are not described herein.

The TCLAS element indicates how to identify the SCS stream, and carries a criterion for determining the SCS stream.

The TCLAS processing element indicates how to process multiple TCLAS elements when the multiple TCLAS elements exist.

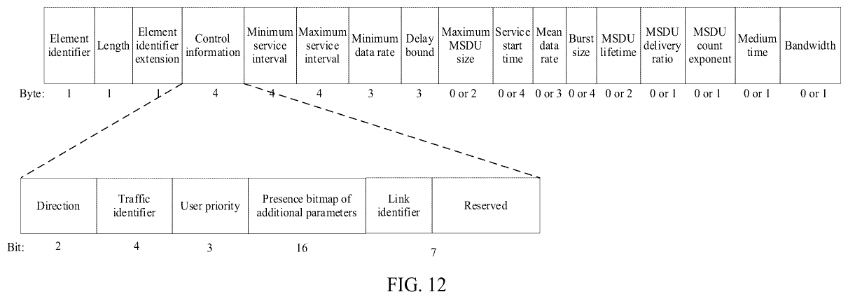

The QoS characteristics element indicates information such as a TID mapped to a corresponding SCS stream and a corresponding QoS parameter. Two most important QoS parameters are a delay bound and a packet delivery ratio. The delay bound indicates a maximum delay allowed for a low-delay packet, and the packet delivery ratio indicates a packet delivery ratio required under a given delay bound requirement. A specific format of the QoS characteristics element is shown in FIG. 12. The QoS characteristics element is described below with reference to FIG. 12. Details are not described herein.

FIG. 11 is a diagram of the intra-access category priority element according to an embodiment of this disclosure.

It can be learned from FIG. 11 that the intra-access category priority element includes the following fields: an element ID, a length, and an intra-access priority. The intra-access priority includes a user priority, an alternate queue, drop eligibility, and reserved.

Further, meanings of the subfields in the intra-access priority field (1 byte) are as follows.

The user priority (3 bits) indicates a priority of a user.

The alternate queue (1 bit) indicates whether to create a new alternate queue for the SCS stream.

Drop eligibility (1 bit) indicates whether a data packet of the SCS stream can be discarded when resources are insufficient.

FIG. 12 is a diagram of the QoS characteristics element according to an embodiment of this disclosure.

It can be learned from FIG. 12 that the QOS characteristics element includes the following fields: an element ID, a length, element ID extension, control information, a minimum service interval, a maximum service interval, a minimum data rate, a delay bound, a maximum MAC service data unit (MSDU) size, a service start time, a mean data rate, a burst size, an MSDU lifetime, an MSDU delivery ratio, an MSDU count exponent, a media time, and a bandwidth. The control information includes the following information: a direction, a traffic identifier, a user priority, a presence bitmap of additional parameters, a link identifier, and reserved.

Further, meanings of the subfields in the control information are as follows.

The direction indicates an uplink when being 00, indicates a downlink when being 10, indicates a peer-to-peer (P2P) direct link when being 01, or indicates reserved when being 11.

The TID has a value ranging from 0 to 7, and has a reserved value ranging from 8 to 15.

The user priority ranges from 0 to 7, and is set to a same value as the TID field.

The presence bitmap of additional parameters is a bitmask used to indicate which additional optional parameters are included in the control information.

The link ID indicates a link identifier corresponding to direct link transmission.

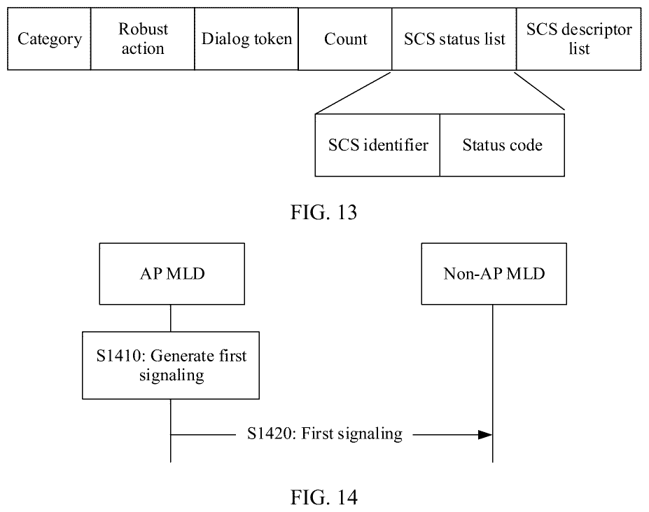

Further, after receiving the SCS request frame, the AP may reply with an SCS response frame. For ease of understanding, a format of the SCS response frame is described with reference to FIG. 13. FIG. 13 is a diagram of the SCS response frame according to an embodiment of this disclosure.

It can be learned from FIG. 13 that the SCS response frame includes the following fields: a category, a robust action, a dialog token, a count, an SCS status list, and an SCS descriptor list. The SCS status list includes an SCS ID and a status code.

Further, meanings of the fields included in the SCS response frame are as follows.

The category indicates a category to which the action frame belongs.

The robust action indicates a frame in the category.

The dialog token needs to be the same as the dialog token in the corresponding SCS request frame.

The count indicates a count of (SCS IDs and status codes) in the SCS status list.

The SCS status list field includes one or more SCS status groups, and carries the SCS ID field and the status code field, where the SCS ID indicates an identifier of an SCS, and the status code indicates whether the requested SCS ID is accepted.

In addition, the following descriptions are first provided to facilitate understanding of embodiments of this disclosure.

First, in this disclosure, the term “indicate” may include a direct indication and an indirect indication. When a piece of indication information is described as indicating A, the indication information may directly indicate A or indirectly indicate A, but it does not indicate that the indication information definitely carries A.

Information indicated by indication information is referred to as to-be-indicated information. In a specific implementation process, there are multiple manners of indicating the to-be-indicated information, for example, but not limited to, the following manners. The to-be-indicated information, for example, the to-be-indicated information or an index of the to-be-indicated information, is directly indicated. Alternatively, the to-be-indicated information may be indirectly indicated by indicating other information, where there is an association relationship between the other information and the to-be-indicated information. Alternatively, only a part of the to-be-indicated information may be indicated, and a remaining part of the to-be-indicated information is known or pre-agreed on. For example, specific information may alternatively be indicated using an arrangement sequence of multiple pieces of information that are pre-agreed on (for example, stipulated in a protocol), to reduce indication overheads to some extent. In addition, a common part of all pieces of information may further be identified and indicated in a unified manner, to reduce indication overheads caused by separately indicating same information.

Second, the terms “first” and “second” and various numerical numbers (for example, “#1” and “#2”) shown in this disclosure are merely for ease of description, and are used to distinguish between objects, but are not intended to limit the scope of embodiments of this disclosure. For example, the numbers are used to distinguish between different information, or distinguish between different STAs, but are not used to describe a particular order or sequence. It should be understood that the objects described in such a way are interchangeable in an appropriate circumstance, so that a solution other than embodiments of this disclosure can be described.

Third, in embodiments of this disclosure, “preset” may include indication by a device using signaling or predefinition, for example, definition in a protocol. “Predefinition” may be implemented by pre-storing, on a device (for example, the device includes a station and an AP), corresponding code or a corresponding table, or may be implemented in another manner that can indicate related information. A specific implementation of “predefinition” is not limited in this disclosure. For example, predefinition may be definition in a protocol.

Fourth, “store” in embodiments of this disclosure may be storing in one or more memories. The one or more memories may be separately disposed, or may be integrated into an encoder, a decoder, a processor, or a communication apparatus. Alternatively, some of the one or more memories may be separately disposed, and some may be integrated into a decoder, a processor, or a communication apparatus. A type of the memory may be a storage medium in any form. This is not limited in this disclosure.

Fifth, in embodiments of this disclosure, a “protocol” may be a standard protocol in the communication field, for example, may include a WLAN protocol and a related protocol applied to a further communication system. This is not limited in this disclosure.

Sixth, in embodiments of this disclosure, “of”, “relevant”, “corresponding”, and “associate” may be interchangeably used sometimes. It should be noted that, when a difference between the terms is not emphasized, meanings to be expressed are consistent.

It can be learned from the foregoing descriptions that an AP MLD can broadcast a TID-to-link mapping for all associated non-AP MLDs to map different TID data traffic to different links and provide differentiated QoS, and can disable a link.

In a possible implementation, related performance of the TID-to-link mapping may be indicated by improving (for example, adding a field to) a TID-to-link mapping element.

For example, a mapping switch count field is added to the TID-to-link mapping element, to indicate a count of target beacon transmission times (TBTTs) that elapse before the TID-to-link mapping takes effect.

For another example, a duration field is added to the TID-to-link mapping element, to indicate how long the TID-to-link mapping takes effect.

It should be understood that the manner of improving the TID-to-link mapping supports only an aperiodic TID-to-link mapping, and cannot support setup of a periodic TID-to-link mapping.

To resolve the problem of the manner of improving the TID-to-link mapping, this disclosure provides a communication method, to define a signaling design of the periodic TID-to-link mapping. With reference to accompanying drawings, the following describes in detail technical solutions provided in this disclosure. Embodiments of this disclosure may be applied to multiple different scenarios, including a scenario shown in FIG. 1, but are not limited to the scenario. It should be understood that a specific structure of an execution body of the method provided in embodiments of this disclosure is not further limited in the following embodiments, provided that a program that records code of the method provided in embodiments of this disclosure can be run to perform communication according to the method provided in embodiments of this disclosure. For example, the execution body of the method provided in embodiments of this disclosure may be a receive end device or a transmit end device, or a functional module that is in a receive end device or a transmit end device and that can invoke a program and execute the program.

Without loss of generality, the following uses interaction between the transmit end device and the receive end device as an example to describe in detail the data transmission method provided in embodiments of this disclosure. In embodiments of this disclosure, the transmit end device is an AP MLD, and the receive end device is a non-AP MLD (for example, a STA MLD). A manner of data transmission between the MLDs is shown in FIG. 5. Details are not described herein again.

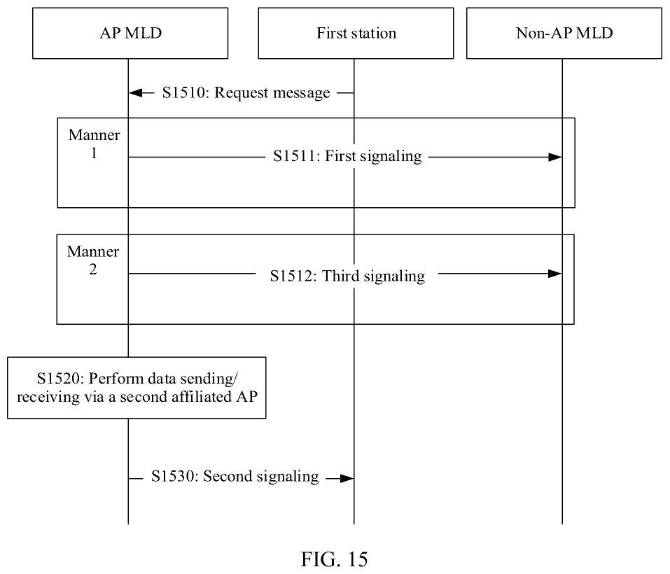

FIG. 14 is a schematic flowchart of a communication method according to an embodiment of this disclosure. The method includes the following steps.

S1410: An AP MLD generates first signaling.

Further, the first signaling indicates a mapping relationship between a traffic identifier and a link. The traffic identifier identifies data traffic, and the link is a transmission link between the AP MLD and a non-AP MLD. The mapping relationship between the traffic identifier and the link indicates that different data traffic is mapped to different links. For example, the first signaling may be an improved TID-to-link mapping. Optionally, the first signaling may also be referred to as a TID-to-link mapping. A name of the signaling is not limited in embodiments of this disclosure, provided that a function of the signaling can be implemented.

Further, the AP MLD generates the first signaling via an affiliated AP affiliated to the AP MLD. For example, the affiliated AP affiliated to the AP MLD includes but is not limited to a first affiliated AP and a second affiliated AP. The first signaling may be generated via the first affiliated AP, and/or the first signaling may be generated via the second affiliated AP.

It should be understood that a specific manner in which the AP MLD generates the first signaling is not limited in embodiments of this disclosure. For details, refer to a manner that is specified in a current protocol and in which the AP MLD generates the TID-to-link mapping.

Further, the following design may be used to enable the mapping relationship indicated by the first signaling to periodically take effect, or enable the first signaling to periodically take effect.

In this embodiment, the first signaling includes first indication information, second indication information, and third indication information. It should be understood that “indication information” in this disclosure may also be understood as a “field”. For example, the first indication information may be referred to as a “first field”, the second indication information may be referred to as a “second field”, and the third indication information may be referred to as a “third field”. Alternatively, functions implemented by the first indication information and the second indication information are implemented using one field. This is not limited in this disclosure. An example in which a function of one piece of indication information is implemented using one field is used for description.

The first indication information indicates a start time at which the mapping relationship takes effect for a 1st time, or the first indication information indicates a start time at which the mapping relationship takes effect.

The second indication information indicates duration in which the mapping relationship takes effect each time. The third indication information indicates an interval between start times or end times at which the mapping relationship takes effect twice consecutively.

For ease of description, the time period in which the mapping relationship takes effect each time may be collectively referred to as a first time period, and the mapping relationship takes effect in multiple first time periods. The interval between the start times or the end times at which the mapping relationship takes effect twice consecutively may be understood as an interval between two adjacent first time periods.

In a possible implementation, that the first indication information indicates a start time at which the mapping relationship takes effect includes that the first indication information indicates that the start time at which the mapping relationship takes effect is a relative time relative to receiving a target beacon. In this implementation, the first indication information may be referred to as a mapping switch count.

For example, the first signaling is carried in the beacon. The first indication information indicates a count of TBTTs that elapse before the mapping relationship indicated by the first signaling takes effect.

In another possible implementation, that the first indication information indicates a start time at which the mapping relationship takes effect includes that the first indication information indicates that the start time at which the mapping relationship takes effect is an absolute time. In this implementation, the first indication information may be referred to as the start time at which the mapping relationship takes effect.

For example, the first indication information may be last four bytes of a timing synchronization function (TSF), and indicates the start time at which the mapping relationship indicated by the first signaling takes effect.

It should be noted that, in this implementation, when the AP MLD broadcasts the first signaling through multiple links, different links correspond to different TSFs. To indicate, using TSFs of the different links, that start times at which the first signaling takes effect are the same, the following manners may be used.

Manner 1: An offset is considered. A TSF of a link is used as a reference, and different offsets are considered for the TSFs of the different links, to indicate a same start time.

Manner 2: A TSF of a link indicates the start time at which the first signaling takes effect.

For example, the first indication information may include the mapping switch count and/or the start time. When both the mapping switch count and the start time are included, either the mapping switch count or the start time is selected as the start time at which the mapping relationship takes effect.

For example, that the second indication information indicates duration of the first time period, and the mapping relationship takes effect in multiple first time periods may be understood as that the second indication information indicates the duration in which the mapping relationship takes effect each time. The second indication information may be referred to as the duration in which the mapping relationship takes effect each time.

For example, that the third indication information indicates an interval between two adjacent first time periods, and the mapping relationship takes effect in multiple first time periods may be understood as that the third indication information indicates an interval between two adjacent first time periods in which the mapping relationship takes effect. The third indication information may be referred to as an interval between two adjacent times that the first signaling takes effect.

For example, the mapping relationship takes effect in three first time periods, and the three first time periods are successively a first time period #1, a first time period #2, and a first time period #3, where an interval between a start time of the first time period #1 and a start time of the first time period #2 is an interval #1, an interval between the start time of the first time period #2 and a start time of the first time period #3 is an interval #2, and the interval #1 and the interval #2 are equal and are collectively referred to as an interval between two adjacent first time periods. The third indication information indicates the interval (for example, the interval #1 or the interval #2) between the two adjacent first time periods.

For another example, the mapping relationship takes effect in three first time periods, and the three first time periods are successively a first time period #1, a first time period #2, and a first time period #3, where an interval between an end time of the first time period #1 and an end time of the first time period #2 is an interval #1, an interval between the end time of the first time period #2 and an end time of the first time period #3 is an interval #2, and the interval #1 and the interval #2 are equal and are collectively referred to as an interval between two adjacent first time periods. The third indication information indicates the interval (for example, the interval #1 or the interval #2) between the two adjacent first time periods.

It can be learned from the foregoing descriptions that the first indication information, the second indication information, and the third indication information can indicate that the mapping relationship takes effect in the multiple first time periods, and indicate the interval between the two adjacent first time periods. This is equivalent to that the mapping relationship can periodically take effect, to periodically indicate the mapping relationship between the traffic identifier and the link, and avoid repeatedly generating, for multiple times, information indicating the mapping relationship between the traffic identifier and the link.

Further, the first signaling may further include fourth indication information. The fourth indication information indicates a count of times that the mapping relationship takes effect, or the fourth indication information indicates a count of first time periods, where the count of first time periods is greater than 1. The fourth indication information may be referred to as the count of first time periods in which the mapping relationship takes effect.

In a special case, when a value of the fourth indication information is 1, it indicates that the mapping relationship is aperiodic (for example, takes effect in one first time period). In other words, when the first signaling includes the fourth indication information, and the value of the fourth indication information is 1, it indicates that the mapping relationship aperiodically takes effective. When the first signaling includes the fourth indication information, and the value of the fourth indication information is greater than 1, it indicates that the mapping relationship periodically takes effect. Optionally, 0 is a reserved value and is forbidden from being used.

In addition, when the value of the fourth indication information is set to 255, it indicates that the mapping relationship always periodically takes effect until the mapping relationship is canceled.

In another special case, that the mapping relationship periodically takes effect or aperiodically takes effect may alternatively be indicated without using the fourth indication information. To be specific, the first signaling may not include the fourth indication information, and that the mapping relationship periodically takes effect or aperiodically takes effect may alternatively be indicated in another manner.

For example, if the third indication information is set to a special value, for example, 0 or 255, it indicates that the mapping relationship aperiodically takes effect. If the third indication information is not set to a special value, the mapping relationship periodically takes effect.

In the foregoing special cases, the mapping relationship can aperiodically take effect or periodically take effect. In comparison with the foregoing solution of improving the TID-to-link mapping element, when the first signaling is the improved TID-to-link mapping element, the improvement manner in this embodiment can expand an application scenario of the TID-to-link mapping.

In an example, the first signaling generated by the AP MLD in this embodiment may be obtained by adding the first indication information, the second indication information, and the third indication information to, and further adding the fourth indication information to a TID-to-link mapping element (for example, shown in FIG. 8) specified in a current protocol.

Further, after generating the first signaling, the AP MLD may send the first signaling to the non-AP MLD associated with the AP MLD. The method procedure shown in FIG. 14 further includes the following step.

S1420: The AP MLD sends the first signaling to the non-AP MLD.

Further, the AP MLD sends, via the affiliated AP affiliated to the AP MLD, the first signaling to the non-AP MLD associated with the AP MLD.

It should be noted that the AP MLD may separately send the first signaling to the non-AP MLD via multiple affiliated APs affiliated to the AP MLD.

For example, a manner of communication between the AP MLD and the non-AP MLD is shown in FIG. 5. In this case, the AP MLD may send the first signaling to the non-AP MLD via an AP #1, an AP #2, and an AP #3 through a link #1, a link #2, and a link #3 respectively.

For example, the AP MLD broadcasts the first signaling for all associated non-AP MLDs. By way of example and not limitation, that the AP MLD sends the first signaling to the non-AP MLD includes that the AP MLD sends, via the affiliated AP, a beacon frame to the non-AP MLD associated with the AP MLD, where the beacon frame includes the first signaling.

For example, the first signaling is a TID-to-link mapping element. The TID-to-link mapping element is carried in the beacon frame.

It should be understood that a name of the first signaling is not limited in this embodiment, and the foregoing TID-to-link mapping element is merely an example, and does not constitute any limitation on the protection scope of this disclosure. Other signaling that can indicate the mapping relationship between the traffic identifier and the link falls within the protection scope of this disclosure.

In addition, how to transmit the first signaling is not limited in this embodiment. That the first signaling is carried in the beacon frame is merely an example, and does not constitute any limitation on the protection scope of this disclosure.

It can be learned from the TID-to-link mapping element described above that, when no TID is mapped to a link of the non-AP MLD, the link is disabled, that is, the non-AP MLD is not allowed to transmit any frame on the link. If the AP broadcasts the TID-to-link mapping element and disables a link, all non-AP MLDs that have set up the link cannot transmit any frame on the link, and the AP MLD cannot transmit any frame on the link either.

In a possible implementation, the first signaling in this embodiment may also indicate that a link is periodically disabled. For example, that the first signaling indicates a mapping relationship between a traffic identifier and a link includes that the first signaling indicates that no traffic identifier is mapped to a link of the first affiliated AP in the first time period. The first affiliated AP may be any one or more of the multiple affiliated APs affiliated to the AP MLD.

In this implementation, because the link of the first affiliated AP is disabled in the first time period, the AP MLD and the non-AP MLD are not allowed to perform data sending/receiving through the link of the first affiliated AP.

It may be understood that, when the link of the first affiliated AP is disabled in the first time period, another affiliated AP (for example, the second affiliated AP) affiliated to the AP MLD may perform data sending/receiving through radio frequency transmit/receive chains of the first affiliated AP and the second affiliated AP in the first time period. With reference to FIG. 15, the following describes in detail how the second affiliated AP performs data sending/receiving through the radio frequency transmit/receive chain of the first affiliated AP and the radio frequency transmit/receive chain of the second affiliated AP.

FIG. 15 is a schematic flowchart of another communication method according to an embodiment of this disclosure. The method includes the following steps.

S1510: A first station sends a request message to the AP MLD.

The AP MLD receives the request message from the first station via the second affiliated AP. The request message is used to request the second affiliated AP to periodically trigger scheduling of the first station for uplink transmission. The request message includes information indicating an interval between two adjacent times of triggering of scheduling. The information indicating the interval between two adjacent times of triggering of scheduling may be referred to as a service interval.

For example, the first station may be a single-link non-AP (for example, a single-link STA), or may be a non-AP MLD. This is not limited in this disclosure.

For example, the request message further includes at least one of the following information: information indicating a start time for triggering scheduling, a service time for triggering scheduling each time, information used to determine a service time for triggering scheduling each time, information indicating an access policy, information (long range request) for requesting a long-range transmission mode service, or information (a received signal strength indicator (RSSI) or a path loss) used to determine whether to use a long-range transmission mode service. A long-range transmission mode means that, because the first station is far away from the AP MLD, has a poor signal, and supports only a low transmission rate, the AP MLD may use a technical means (for example, increasing a count of transceiver antennas) to increase a transmission rate and a transmission range of the first station.

Optionally, the information used to determine the service time for triggering scheduling each time includes but is not limited to an amount of data that needs to be transmitted to trigger scheduling each time, a modulation and coding scheme (MCS) that the first station expects to use, and the like. The second affiliated AP may determine the service time for triggering scheduling each time based on the information used to determine the service time for triggering scheduling each time.

Optionally, the information indicating the access policy may indicate access in an EDCA-based manner, or may indicate access in a trigger-based only manner, that is, the second affiliated AP needs to send a trigger frame to trigger the first station for uplink transmission. In this embodiment, an access manner of the first station is a manner of sending the trigger frame based on the second affiliated AP.

Optionally, the information used to determine whether to use the long-range transmission mode service includes but is not limited to a downlink beacon RSSI or a path loss reported by the first station. The second affiliated AP may determine, based on the information used to determine whether to use the long-range transmission mode service, whether to use the long-range transmission mode to serve the first station.

In a possible implementation, that the first station sends the request message to the second affiliated AP of the AP MLD includes that the first station sends an SCS request frame to the second affiliated AP of the AP MLD. The SCS request frame is used to request to add a traffic stream. Further, a QoS characteristics element carried in the SCS request frame is used to report a characteristic (for example, the information included in the request message) of the traffic stream.

Further, after receiving the request message, the second affiliated AP of the AP MLD determines, based on the information for requesting the long-range transmission mode service, to use the long-range transmission mode with the first station, or determines, based on the information used to determine whether to use the long-range transmission mode service, to use the long-range transmission mode with the first station. To improve an uplink transmission rate of the first station, the AP MLD may perform data sending/receiving with the first station via the second affiliated AP through the radio frequency transmit/receive chain of the second affiliated AP and all or a part of radio frequency transmit/receive chains of another affiliated AP affiliated to the AP MLD. The method procedure shown in FIG. 15 further includes the following steps.

S1520: The AP MLD performs data sending/receiving via the second affiliated AP.

Further, the AP MLD performs data sending/receiving with the first station via the second affiliated AP through the radio frequency transmit/receive chain of the second affiliated AP and a first radio frequency transmit/receive chain of the other affiliated AP (for example, the first affiliated AP) affiliated to the AP MLD.

For example, in this embodiment, the AP MLD may perform data sending/receiving via the second affiliated AP through the first radio frequency transmit/receive chain of the other affiliated AP other than the radio frequency transmit/receive chain of the second affiliated AP in the following two possible manners,

Manner 1: The first radio frequency transmit/receive chain is all of radio frequency transmit/receive chains of the first affiliated AP.

In the implementation 1, when the link of the first affiliated AP is disabled, the first affiliated AP cannot use the radio frequency Tx/Rx chain of the first affiliated AP, and the Tx/Rx chain of the first affiliated AP may be switched to a channel of the second affiliated AP. In other words, the second affiliated AP may perform data sending/receiving through all of the radio frequency transmit/receive chains of the first affiliated AP. That the link of the first affiliated AP is disabled means that the AP sends BSS-wide link disablement to indicate that the corresponding link is disabled. In this period, the first affiliated AP or a STA associated with the first affiliated AP are forbidden from data transmission.

In a possible implementation, BSS-wide link disablement may be indicated by the TID-to-link mapping, that is, no traffic identifier is mapped to the link.

In another possible implementation, BSS-wide link disablement may be indicated in another manner. For example, one bit is used to directly indicate that the link is disabled. In addition, link disablement herein may also be referred to as AP absence or link unavailability. This is not limited.

For ease of understanding, the following uses an example in which the TID-to-link mapping indicates that the link of the first affiliated AP is disabled for description. Further, the AP MLD may indicate, using the TID-to-link mapping element, that the link of the first affiliated AP is disabled.

In manner 1, the method procedure shown in FIG. 15 further includes the following step.

S1511: The AP MLD sends the first signaling to the non-AP MLD.

In a possible implementation, the first signaling may be the TID-to-link mapping element. In this implementation, refer to the descriptions of S1420. Details are not described herein again. The non-AP MLD includes a non-AP MLD associated with the first affiliated AP.

In another possible implementation, the first signaling may be signaling other than the TID-to-link mapping element, for example, a 1-bit field. When a value of the field is 1, it indicates that the link of the AP is disabled. To be specific, the corresponding link is stopped from being used. In this period, the AP or the associated STA are both forbidden from data transmission.

In this embodiment, the first signaling indicates that the link of the first affiliated AP is disabled. Optionally, if the first signaling periodically takes effect, the link of the first affiliated AP is periodically disabled.

For example, if the link of the first affiliated AP is disabled in the multiple first time periods, the second affiliated AP may perform data sending/receiving in the multiple first time periods through the radio frequency transmit/receive chain of the second affiliated AP and all of the radio frequency transmit/receive chains of the first affiliated AP. For related descriptions of the first time period, refer to the descriptions of the embodiment shown in FIG. 14. Details are not described herein again.

In a possible implementation, a related parameter of the first signaling (for example, the start time at which the mapping relationship indicated by the first signaling takes effect, the duration in which the mapping relationship indicated by the first signaling takes effect each time, the interval between two adjacent times that the mapping relationship indicated by the first signaling takes effect, or the count of first time periods in which the mapping relationship indicated by the first signaling takes effect) is determined based on a parameter carried in the request message (for example, the start time for triggering scheduling, the service time for triggering scheduling each time, or the interval between two adjacent times of triggering of scheduling).

For example, the second affiliated AP of the AP MLD may determine, based on the start time for triggering scheduling, the service time for triggering scheduling each time (or the amount of the data that needs to be transmitted for triggering scheduling each time), and a service interval for triggering scheduling that are included in the request message, a value of the start time in the first signaling, a value of duration of each first time period, and a value of the interval between the two adjacent first time periods.

Manner 2: The first radio frequency transmit/receive chain is a part of radio frequency transmit/receive chains of the first affiliated AP.

In the implementation 2, the first affiliated AP can use only a part of the radio frequency transmit/receive chains (for example, a second radio frequency transmit/receive chain) when performing data sending/receiving. In this case, another radio frequency transmit/receive chain (for example, the first radio frequency transmit/receive chain) may be switched to a channel of the second affiliated AP, that is, the second affiliated AP may perform data sending/receiving through the part of the radio frequency transmit/receive chains of the first affiliated AP.

Further, the AP MLD may indicate, using third signaling, that only the part of the radio frequency transmit/receive chains can be used during data sending/receiving.

In manner 2, the method procedure shown in FIG. 15 further includes the following step.

S1512: The AP MLD sends the third signaling to the non-AP MLD.

Further, the third signaling indicates to perform transmission between the non-AP MLD and the first affiliated AP through the radio frequency transmit/receive chain other than the first radio frequency transmit/receive chain. The non-AP MLD includes a non-AP MLD associated with the first affiliated AP.

Optionally, the third signaling may indicate that the first affiliated AP cannot periodically use the first radio frequency transmit/receive chain. For example, the third signaling may indicate that the first affiliated AP cannot use the first radio frequency transmit/receive chain in the multiple first time periods. For related descriptions of the first time period, refer to the descriptions of the embodiment shown in FIG. 14. Details are not described herein again.

In manner 2, the first affiliated AP may perform data sending/receiving through the radio frequency transmit/receive chain other than the first radio frequency transmit/receive chain, to serve a station associated with the first affiliated AP.

In a possible implementation, the third signaling may be trigger-enabled TWT signaling, and indicates that, in a time period (for example, the multiple first time periods), data sending/receiving needs to be performed based on scheduling by a trigger frame of the AP MLD. A count of streams sent by the station is specified when the trigger frame triggers scheduling.

In manner 1 and manner 2, the second affiliated AP can perform data sending/receiving through the part or all of the radio frequency transmit/receive chains of the first affiliated AP. Manner 1 and manner 2 are merely examples, and do not constitute any limitation on the protection scope of this disclosure. Alternatively, the second affiliated AP may perform data sending/receiving in another manner through the first radio frequency transmit/receive chain of the first affiliated AP. For example, it is predefined in a protocol that the first affiliated AP cannot perform data sending/receiving in some time periods through the first radio frequency transmit/receive chain. For another example, a management device configures that the first affiliated AP cannot perform data sending/receiving in some time periods through the first radio frequency transmit/receive chain. Examples are not provided one by one for description herein.

Further, in manner 1 and manner 2, that the first affiliated AP may not periodically use the first radio frequency transmit/receive chain to perform data sending/receiving, for example, not use the first radio frequency transmit/receive chain in the multiple first time periods, is described. Therefore, the second affiliated AP may use the first radio frequency transmit/receive chain in the multiple first time periods. Further, in consideration of power consumption of a station associated with the second affiliated AP, the station associated with the second affiliated AP may be indicated to wake up in some time periods (for example, multiple second time periods) to communicate with the second affiliated AP. The method procedure shown in FIG. 15 further includes the following step.

S1530: The AP MLD sends second signaling to the first station.

Further, the second signaling indicates the first station to communicate with the second affiliated AP in time periods in which the first station is woken up.

For ease of description, the time periods in which the first station is woken up may be collectively referred to as the second time period, and the first station is periodically woken up in the multiple second time periods.

In a possible implementation, the second time period is the same as the first time period. In other words, the first station is woken up in the second time period, performs data transmission with the second affiliated AP through the radio frequency transmit/receive chain of the second affiliated AP and the first radio frequency transmit/receive chain of the first affiliated AP, and may be in a sleep state or another power-saving state in another time period.

In this implementation, a start time of the second time period is the same as a start time of the corresponding first time period, duration of the second time period is the same as duration of the first time period, and a count of second time periods is the same as the count of first time periods.

In another possible implementation, a switching time for switching the first Tx/Rx chain of the first affiliated AP to the channel of the second affiliated AP is considered. A time difference between a start time of the second time period and a start time of a corresponding first time period is a first threshold. A time difference between an end time of the second time period and an end time of the corresponding first time period is the first threshold. The first threshold is the switching time.

In this implementation, the start time of the second time period is the first threshold later than the start time of the corresponding first time period. The end time of the second time period is the first threshold earlier than the end time of the corresponding first time period. A count of second time periods is the same as the count of first time periods.

The first time period corresponding to the second time period may be understood as a first time period that is in the multiple first time periods and whose time domain order is the same as a time domain order of the second time period in the multiple second time periods.

For example, a sequence of the three first time periods in time domain is successively the first time period #1, the first time period #2, and the first time period #3, and a sequence of three second time periods in time domain is successively a second time period #1, a second time period #2, and a second time period #3. The first time period #1 is a first time period corresponding to the second time period #1, the first time period #2 is a first time period corresponding to the second time period #2, and the first time period #3 is a first time period corresponding to the second time period #3.

It should be understood that, when the interval between the two adjacent first time periods is expressed as an interval between a start time of a previous first time period and a start time of a next first time period, and an interval between two adjacent second time periods is expressed as an interval between a start time of a previous second time period and a start time of a next second time period, the interval between the two adjacent second time periods is the same as the interval between the two adjacent first time periods.

When the interval between the two adjacent first time periods is expressed as an interval between an end time of a previous first time period and an end time of a next first time period, and an interval between two adjacent second time periods is expressed as an interval between an end time of a previous second time period and an end time of a next second time period, the interval between the two adjacent second time periods is the same as the interval between the two adjacent first time periods.

However, if the interval between the two adjacent first time periods is expressed as an interval between an end time of a previous first time period and a start time of a next first time period, and an interval between two adjacent second time periods is expressed as an interval between an end time of a previous second time period and a start time of a next second time period, the interval between the two adjacent second time periods is a sum of the interval between the two adjacent first time periods and twice the first threshold.

It can be learned from the foregoing descriptions that, that the first station sends the request message to the AP MLD may be that the first station sends the SCS request frame to the second affiliated AP of the AP MLD. In this case, that the AP MLD sends the second signaling to the first station may be that the second affiliated AP sends an SCS response frame to the first station after receiving the SCS request frame. The SCS response frame may carry an unsolicited TWT element. The unsolicited TWT element indicates the second affiliated AP to set up an rTWT, and enables the first station to join the rTWT, so that the first station is woken up in the second time period to communicate with the second affiliated AP.

For ease of understanding, the following describes, with reference to a specific example, how the second affiliated AP performs data sending/receiving through the radio frequency transmit/receive chain of the first affiliated AP and the radio frequency transmit/receive chain of the second affiliated AP.

### Example 1

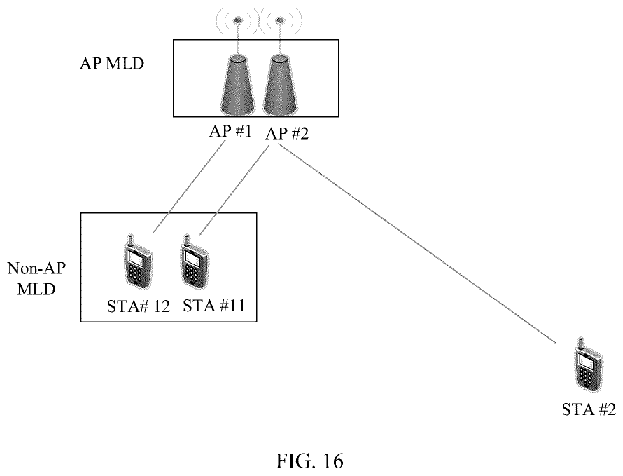

Refer to a scenario shown in FIG. 16. FIG. 16 is a diagram of a long-range transmission scenario according to an embodiment of this disclosure. An AP MLD has two affiliated APs (for example, an AP #1 and an AP #2 shown in FIG. 16). The AP #1 is associated with one non-AP MLD. The non-AP MLD has two affiliated STAs (for example, a STA #11 and a STA #12 shown in FIG. 16). The AP #2 is associated with one single-link STA (for example, a STA #2 shown in FIG. 16).

For example, the STA #2 may be a doorbell, and is associated with the AP #2. The STA #2 is far away from the AP #2, and therefore supports only a low transmission rate.

Further, in the scenario shown in FIG. 16, that the AP #2 uses both a Tx/Rx chain of the AP #2 and a Tx/Rx chain of the AP #1 to serve the STA #2 includes the following steps.

Step 1: The STA #2 sends a request message to the AP #2, to request the AP #2 to periodically trigger the STA #2 for uplink transmission.

For example, when a guest arrives and presses the doorbell, the STA #2 sends the request message to the AP #2. For related descriptions of the request message, refer to the descriptions of the request message in S1510. Details are not described herein again.

Step 2: The AP #2 determines to serve the STA #2 in a long-range transmission mode.

For example, the following step 3a and step 4a are performed, so that the AP #2 performs data sending/receiving through all of radio frequency transmit/receive chains of the AP #1 and a radio frequency transmit/receive chain of the AP #2.

Step 3a: The AP MLD sets up periodic link disablement scheduling on a link of the AP #1. A related parameter of periodic link disablement scheduling may be determined based on a parameter carried in the request message sent by the STA #2. For a specific setup process, refer to the descriptions of manner 1 in FIG. 15. Details are not described herein again. Further, periodic link disablement scheduling is set up using first signaling, so that the non-AP MLD associated with the AP #1 does not send data to the AP #1 in a link disablement period.

Alternatively, the AP MLD sets up a periodic quiet period on the link of the AP #1 using a quiet element. Further, the periodic quiet period is set up using the quiet element, so that a legacy STA associated with the AP #1 can parse the quiet element and does not send data to the AP #1 in the quiet period.

Alternatively, the AP MLD sets up periodic link disablement scheduling on the link of the AP #1, and sets up, using a quiet element, a periodic quiet period whose start time is aligned with the link disablement scheduling. Further, the periodic link disablement scheduling is set up, and the periodic quiet period is set up using the quiet element, so that both stations (the non-AP MLD and a legacy STA) associated with the AP #1 do not send data in a first time period. The first time period indicates a scheduling time period for link disablement and a quiet period corresponding to the quiet element.

For ease of description, setting up periodic link disablement scheduling is used as an example for description.

Step 4a: The AP #2 sets up, on a link of the AP #2, a trigger-enabled rTWT that is aligned with link disablement in time, and enables the STA #2 to join the rTWT as a member.

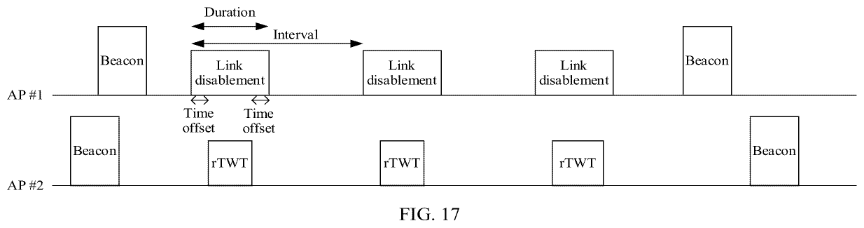

It should be noted that time alignment between the trigger-enabled rTWT and link disablement may be that a start time of an rTWT SP on the link of the AP #2 and a start time of scheduled link disablement on the link of the AP #1 are staggered by a fixed time (a time offset), and an end time of the rTWT SP on the link of the AP #2 and an end time of scheduled link disablement on the link of the AP #1 are staggered by the fixed time. The fixed time is a time required for the Tx/Rx chain of the AP #1 to switch from a channel, on which the link of the AP #1 operates, to a channel on which the link of the AP #2 operates. As shown in FIG. 17, FIG. 17 is a diagram of a correspondence between the rTWT and link disablement according to an embodiment of this disclosure.

For example, the following step 3b and step 4b are performed, so that the AP #2 performs data sending/receiving through a part of radio frequency transmit/receive chains of the AP #1 and a radio frequency transmit/receive chain of the AP #2.

Step 3b: The AP #1 sets up a trigger-enabled TWT #1 on a link of the AP #1. During the TWT #1 SP, the AP #1 can only perform sending/receiving through a few Tx/Rx chains, and a remaining Tx/Rx chain is switched to a channel on which the link of the AP #2 is located, to improve a sending/receiving rate of the AP #2.

Step 4b: The AP #2 sets up, on a link of the AP #2, a trigger-enabled rTWT that is aligned with a TWT SP in time, and enables the STA #2 to join the rTWT as a member.

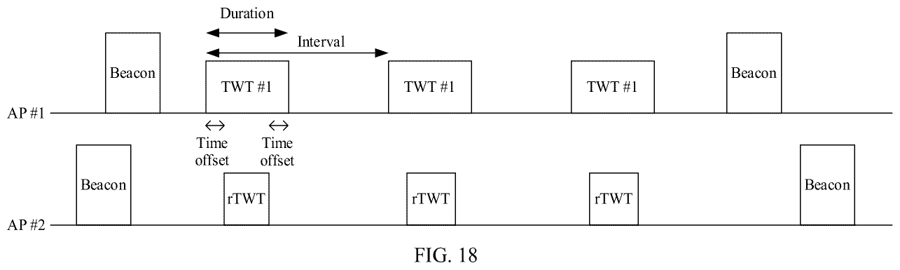

It should be noted that time alignment between the trigger-enabled rTWT and the trigger-enabled TWT #1 may be that a start time of the rTWT SP on the link of the AP #2 and a start time of the scheduled TWT #1 SP on the link of the AP #1 are staggered by a fixed time (a time offset), and an end time of the rTWT SP on the link of the AP #2 and an end time of the scheduled TWT #1 SP on the link of the AP #1 are staggered by the fixed time. The fixed time is a time required for the Tx/Rx chain of the AP #1 to switch from a channel, on which the link of the AP #1 operates, to a channel on which the link of the AP #2 operates. As shown in FIG. 18, FIG. 18 is a diagram of a correspondence between the rTWT and the TWT #1 according to an embodiment of this disclosure.

Step 5: During the rTWT, the AP #2 may serve the STA #2 through the Tx/Rx chain of the AP #2 and the part or all of the Tx/Rx chains of the AP #1.

It should be understood that the specific examples shown in FIG. 14 and FIG. 15 in embodiments of this disclosure are merely intended to help a person skilled in the art better understand embodiments of this disclosure, but are not intended to limit the scope of embodiments of this disclosure. It should be further understood that sequence numbers of the foregoing processes do not mean an execution sequence of the processes. The execution sequence of the processes should be determined based on functions and internal logic of the processes, and should not be construed as any limitation on the implementation processes of embodiments of this disclosure.

It should be further understood that, in embodiments of this disclosure, unless otherwise stated or there is a logic conflict, terms and/or descriptions in different embodiments are consistent and may be mutually referenced, and technical features in different embodiments may be combined based on an internal logical relationship thereof, to form a new embodiment.

It should be further understood that, in some of the foregoing embodiments, a device in an existing network architecture is mainly used as an example for description. It should be understood that a specific form of the device is not limited in embodiments of this disclosure. For example, all devices that can implement a same function in the future are applicable to embodiments of this disclosure.

It may be understood that, in the foregoing method embodiments, methods and operations implemented by devices (for example, the AP MLD and the non-AP MLD) may alternatively be implemented by components (for example, chips or circuits) that can be used in the devices.

With reference to FIG. 14 and FIG. 15, the foregoing describes in detail the communication method provided in embodiments of this disclosure. The foregoing communication method is mainly described from a perspective of interaction between the AP MLD and the non-AP MLD. It may be understood that, to implement the foregoing functions, the AP MLD and the non-AP MLD include corresponding hardware structures and/or software modules for performing the functions.

A person skilled in the art should be aware that, in combination with units and algorithm steps of the examples described in embodiments disclosed in this specification, this disclosure can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

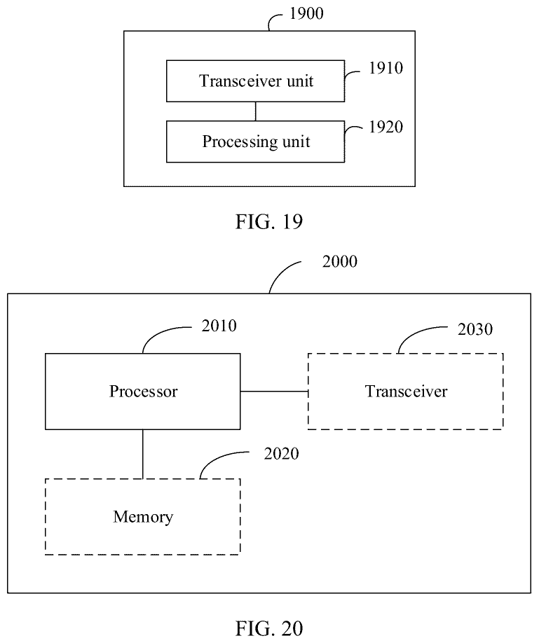

With reference to FIG. 19 and FIG. 20, the following describes in detail an MLD provided in embodiments of this disclosure. It should be understood that descriptions of apparatus embodiments correspond to the descriptions of the method embodiments. Therefore, for content that is not described in detail, refer to the foregoing method embodiments. For brevity, some content is not described again.

In embodiments of this disclosure, a transmit end device or a receive end device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this disclosure, division into the modules is an example, is merely logical function division, and may be other division during actual implementation. The following uses an example in which each functional module is obtained through division based on each corresponding function for description.

FIG. 19 is a block diagram of an apparatus 1900 according to an embodiment of this disclosure. The apparatus 1900 includes a transceiver unit 1910 and a processing unit 1920. The transceiver unit 1910 may implement a corresponding communication function, and the processing unit 1920 is configured to perform data processing. The transceiver unit 1910 may also be referred to as a communication interface or a communication unit.

Optionally, the apparatus 1900 may further include a storage unit. The storage unit may be configured to store instructions and/or data. The processing unit 1920 may read the instructions and/or the data in the storage unit, to enable the apparatus to implement the foregoing method embodiments.

The apparatus 1900 may be configured to perform actions performed by MLDs (for example, the AP MLD and the non-AP MLD) in the foregoing method embodiments. In this case, the apparatus 1900 may be an MLD or a component that can be configured in a MLD. The transceiver unit 1910 is configured to perform sending and receiving-related operations of the MLDs in the foregoing method embodiments. The processing unit 1920 is configured to perform processing-related operations of the MLDs in the foregoing method embodiments.

In a design, the apparatus 1900 is configured to perform an action performed by the AP MLD in the foregoing method embodiments.

In a possible implementation, the processing unit 1920 is configured to generate first signaling via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively.

The transceiver unit 1910 is configured to send, via the affiliated AP, the first signaling to a non-AP MLD associated with the AP MLD.

In another possible implementation, the transceiver unit 1910 is configured to receive a request message from a first station via a second affiliated AP, where the request message is used to request the second affiliated AP to periodically trigger scheduling of the first station for uplink transmission, and the request message includes information indicating an interval between two adjacent times of triggering of scheduling. The processing unit 1920 is configured to perform data sending/receiving with the first station via the second affiliated AP through a radio frequency transmit/receive chain of the second affiliated AP and a first radio frequency transmit/receive chain of a first affiliated AP, where the first radio frequency transmit/receive chain is all or a part of radio frequency transmit/receive chains of the first affiliated AP.

The apparatus 1900 may implement the steps or procedures performed by the AP MLD in the method embodiments in embodiments of this disclosure. The apparatus 1900 may include units configured to perform the methods performed by the AP MLD in the method embodiments. In addition, the units in the apparatus 1900 and the foregoing other operations and/or functions are separately used to implement corresponding procedures in the method embodiments of the AP MLD in the method embodiments.

When the apparatus 1900 is configured to perform the method in FIG. 14, the transceiver unit 1910 may be configured to perform sending and receiving steps in the method, for example, step S1420, and the processing unit 1920 may be configured to perform processing steps in the method, for example, step S1410.

When the apparatus 1900 is configured to perform the method in FIG. 15, the transceiver unit 1910 may be configured to perform sending and receiving steps in the method, for example, steps S1510, S1511, S1512, and S1530, and the processing unit 1920 may be configured to perform processing steps in the method, for example, step S1520.

It should be understood that a specific process in which the units perform the foregoing corresponding steps is described in detail in the foregoing method embodiments. For brevity, details are not described herein again.

In another design, the apparatus 1900 is configured to perform an action performed by the non-AP MLD in the foregoing method embodiments.

The transceiver unit 1910 is configured to receive first signaling sent by an AP MLD, that is associated with the non-AP MLD, via an affiliated AP affiliated to the AP MLD, where the first signaling indicates a mapping relationship between a traffic identifier and a link, the mapping relationship periodically takes effect, and the first signaling includes first indication information, second indication information, and third indication information, where the first indication information indicates a start time at which the mapping relationship takes effect for a 1st time, the second indication information indicates duration in which the mapping relationship takes effect each time, and the third indication information indicates an interval between start times or end times at which the mapping relationship takes effect twice consecutively. The processing unit 1920 is configured to determine a transmission link for data traffic based on the first signaling.

The apparatus 1900 may implement the steps or procedures performed by the non-AP MLD in the method embodiments in embodiments of this disclosure. The apparatus 1900 may include units configured to perform the methods performed by the non-AP MLD in the method embodiments. In addition, the units in the apparatus 1900 and the foregoing other operations and/or functions are separately used to implement corresponding procedures in the method embodiments of the non-AP MLD in the method embodiments.

When the apparatus 1900 is configured to perform the method in FIG. 14, the transceiver unit 1910 may be configured to perform sending and receiving steps in the method, for example, step S1420.

When the apparatus 1900 is configured to perform the method in FIG. 15, the transceiver unit 1910 may be configured to perform sending and receiving steps in the method, for example, steps S1511 and S1512.

It should be understood that a specific process in which the units perform the foregoing corresponding steps is described in detail in the foregoing method embodiments. For brevity, details are not described herein again.

In still another design, the apparatus 1900 is configured to perform an action performed by the first station in the foregoing method embodiments.

The transceiver unit 1910 is configured to send a request message to a second affiliated AP associated with the first station, where the request message is used to request the second affiliated AP to periodically trigger scheduling of the first station for uplink transmission, and the request message includes information indicating an interval between two adjacent times of triggering of scheduling. The processing unit 1920 is configured to perform data sending/receiving with the second affiliated AP through a radio frequency transmit/receive chain of the second affiliated AP and a first radio frequency transmit/receive chain of a first affiliated AP.

The apparatus 1900 may implement the steps or procedures performed by the first station in the method embodiments in embodiments of this disclosure. The apparatus 1900 may include units configured to perform the methods performed by the first station in the method embodiments. In addition, the units in the apparatus 1900 and the foregoing other operations and/or functions are separately used to implement corresponding procedures in the method embodiments of the first station in the method embodiments.

When the apparatus 1900 is configured to perform the method in FIG. 15, the transceiver unit 1910 may be configured to perform sending and receiving steps in the method, for example, steps S1510 and S1530.

The processing unit 1920 in the foregoing embodiment may be implemented by at least one processor or a processor-related circuit. The transceiver unit 1910 may be implemented by a transceiver or a transceiver-related circuit. The storage unit may be implemented by at least one memory.

As shown in FIG. 20, an embodiment of this disclosure further provides an apparatus 2000. The apparatus 2000 includes a processor 2010, and may further include one or more memories 2020. The processor 2010 is coupled to the memory 2020. The memory 2020 is configured to store a computer program or instructions and/or data. The processor 2010 is configured to execute the computer program or the instructions and/or the data stored in the memory 2020, so that the methods in the foregoing method embodiments are performed. Optionally, the apparatus 2000 includes one or more processors 2010.

Optionally, the memory 2020 and the processor 2010 may be integrated or separately disposed.

Optionally, as shown in FIG. 20, the apparatus 2000 may further include a transceiver 2030. The transceiver 2030 is configured to receive a signal and/or send a signal. For example, the processor 2010 is configured to control the transceiver 2030 to receive the signal and/or send the signal.

In a solution, the apparatus 2000 is configured to implement operations performed by MLDs (for example, the AP MLD and the non-AP MLD) in the foregoing method embodiments.

An embodiment of this disclosure further provides a computer-readable storage medium. The computer-readable storage medium stores computer instructions used to implement the methods performed by MLDs (for example, the AP MLD and the non-AP MLD) in the foregoing method embodiments.

For example, when the computer program is executed by a computer, the computer is enabled to implement the methods performed by MLDs (for example, the AP MLD and the non-AP MLD) in the foregoing method embodiments.

An embodiment of this disclosure further provides a computer program product including instructions. When the instructions are executed by a computer, the computer is enabled to implement the methods performed by MLDs (for example, the AP MLD and the non-AP MLD) in the foregoing method embodiments.

An embodiment of this disclosure further provides a communication system. The communication system includes the AP MLD and the non-AP MLD in the foregoing embodiments.

For explanations and beneficial effects of related content of any one of the apparatuses provided above, refer to the corresponding method embodiments provided above. Details are not described herein again.

It should be understood that the processor mentioned in embodiments of this disclosure may be a central processing unit (CPU), or may be another general-purpose processor, a digital signal processor (DSP), an application-specific integrated circuit (ASIC), a field-programmable gate array (FPGA) or another programmable logic device, a discrete gate or a transistor logic device, a discrete hardware component, or the like. The general-purpose processor may be a microprocessor, or another processor or the like.

It should be further understood that the memory mentioned in embodiments of this disclosure may be a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random-access memory (RAM). For example, the RAM may be used as an external cache. By way of example and not limitation, the RAM may include the following multiple forms: a static RAM (SRAM), a dynamic RAM (DRAM), a synchronous DRAM (SDRAM), a Double Data Rate (DDR) SDRAM, an enhanced SDRAM (ESDRAM), a synchlink DRAM (SLDRAM), and a Direct Rambus (DR) RAM.

It should be noted that, when the processor is a general-purpose processor, a DSP, an ASIC, an FPGA or another programmable logic device, a discrete gate or a transistor logic device, or a discrete hardware component, the memory (a storage module) may be integrated into the processor.

It should be further noted that the memory described herein is intended to include, but is not limited to, these and any other suitable type of memory.

A person of ordinary skill in the art may be aware that, in combination with the examples described in embodiments disclosed in this specification, units and steps may be implemented by electronic hardware or a combination of computer software and electronic hardware. Whether these functions are performed by hardware or software depends on particular applications and design constraints of the technical solutions. A person skilled in the art may use different methods to implement the described functions for each particular application, but it should not be considered that the implementation goes beyond the protection scope of this disclosure.

In the several embodiments provided in this disclosure, it should be understood that the disclosed apparatuses and methods may be implemented in other manners. For example, the described apparatus embodiments are merely examples. For example, division into the units is merely logical function division, and may be other division during actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one place, or may be distributed on multiple network units. A part or all of the units may be selected based on an actual requirement, to implement the solutions provided in this disclosure.

In addition, functional units in embodiments of this disclosure may be integrated into one unit, each of the units may exist alone physically, or two or more units may be integrated into one unit.

All or some of the foregoing embodiments may be implemented using software, hardware, firmware, or any combination thereof. When software is used to implement embodiments, all or some of embodiments may be implemented in a form of a computer program product. The computer program product includes one or more computer instructions. When the computer program instruction is loaded and executed on a computer, the procedure or functions according to embodiments of this disclosure are all or partially generated. The computer may be a general-purpose computer, a dedicated computer, a computer network, or another programmable apparatus. For example, the computer may be a personal computer, a server, or a network device. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device like a server or a data center, integrating one or more usable media. The usable medium may be a magnetic medium (for example, a floppy disk, a hard disk, or a magnetic tape), an optical medium (for example, a DIGITAL VERSATILE DISC (DVD)), a semiconductor medium (for example, a solid-state disk (SSD)), or the like. For example, the usable medium may include but is not limited to any medium that can store program code, for example, a Universal serial Bus (USB) flash drive, a removable hard disk, a ROM, a RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

The invention claimed is:

1. A method implemented by an access point (AP) multi-link device (MLD), wherein the method comprises:
generating first signaling using a first affiliated AP affiliated to the AP MLD, wherein the first signaling indicates a mapping relationship between a traffic identifier and a link, and wherein the first signaling comprises first indication information indicating a start time at which the mapping relationship takes effect for a a first time, second indication information indicating a duration in which the mapping relationship takes effect each time, and third indication information indicating an interval between consecutive start times or end times at which the mapping relationship takes effect; and
sending, using the first affiliated AP, the first signaling to a non-AP MLD associated with the AP MLD.

2. The method of claim 1, wherein the first signaling further comprises fourth indication information indicating a count of times that the mapping relationship takes effect, and wherein the count of times is greater than 1.

3. The method of claim 1, wherein sending the first signaling comprises sending, using the affiliated AP, a beacon frame to the non-AP MLD, and wherein the beacon frame comprises the first signaling.

4. The method of claim 1, further comprising performing data sending/receiving using a second affiliated AP through radio frequency transmit/receive chains of the first affiliated AP and the second affiliated AP when the first signaling indicates that the traffic identifier is not mapped to the link of the first affiliated AP during a time period in which the mapping relationship takes effect.

5. The method of claim 1, further comprising:
sending, to a first station via a using a second affiliated AP, second signaling instructing the first station to communicate with the second affiliated AP during a first time period in which the first station is woken up, wherein the first station is associated with the second affiliated AP, wherein a start time of the first time period is a first threshold later than a start time of a corresponding time period in which the mapping relationship takes effect, wherein an end time of the first time period is the first threshold earlier than an end time of the corresponding time period, wherein a first count of time periods in which the first station is woken up is the same as a second count of time periods in which the mapping relationship takes effect, and wherein the first signaling indicates that the traffic identifier is not mapped to the link of the first affiliated AP during a second time period in which the mapping relationship takes effect; and
performing data sending/receiving via using the second affiliated AP through radio frequency transmit/receive chains of the first affiliated AP and the second affiliated AP during the first time period.

6. The method of claim 4, further comprising receiving, from a first station and using the second affiliated AP, a request message requesting the second affiliated AP to periodically trigger scheduling of the first station for uplink transmission wherein the request message comprises first information indicating an interval between two adjacent times of triggering of scheduling.

7. The method of claim 6, wherein the request message further comprises at least one of:
second information indicating a start time for triggering scheduling;
third information indicating a service time for triggering scheduling each time;
fourth information for determining the service time;
fifth information indicating an access policy;
sixth information for requesting a long-range transmission mode service; or
seventh information for determining whether to use the long-range transmission mode service.

8. The method of claim 7, wherein generating the first signaling comprises generating, using the first affiliated AP, the first signaling based on the request message.

9. A method implemented by a non-access point (AP) multi-link device (MLD) associated with an AP MLD, wherein the method comprises:
receiving, from the AP MLD, first signaling using a first affiliated AP affiliated to the AP MLD, wherein the first signaling indicates a mapping relationship between a traffic identifier and a link, wherein the first signaling comprises first indication information, indicating a start time at which the mapping relationship takes effect for a first time, second indication information indicating a duration in which the mapping relationship takes effect each time, and third indication information indicating an interval between consecutive start times or end times at which the mapping relationship takes effect; and
determining, based on the first signaling, a transmission link for data traffic.

10. The method of claim 9, wherein the first signaling further comprises fourth indication information indicating a count of times that the mapping relationship takes effect, and wherein the count of times is greater than 1.

11. The method of claim 9, wherein receiving the first signaling comprises receiving, from the AP MLD and using the first affiliated AP a beacon frame comprising the first signaling.

12. The method of claim 9, further comprising receiving, from a second affiliated AP, second signaling instructing the non-AP MLD to communicate with the second affiliated AP during a first time period in which the non-AP MLD is woken up, wherein a start time of the first time period is a first threshold later than a start time of a corresponding time period in which the mapping relationship takes effect, wherein an end time of the first time period is the first threshold earlier than an end time of the corresponding time period, wherein a first count of time periods in which the non-AP MLD is woken up is the same as a second count of time periods in which the mapping relationship takes effect, and wherein the first signaling indicates that the traffic identifier is not mapped to the link of the first affiliated AP during a second time period in which the mapping relationship takes effect.

13. The method of claim 12, further comprising sending, to the second affiliated AP, a request message requesting the second affiliated AP to periodically trigger scheduling of a first station for uplink transmission, wherein the request message comprises first information indicating an interval between two adjacent times of triggering of scheduling.

14. The method of claim 13, wherein the request message further comprises at least one of:
second information indicating a start time for triggering scheduling;
third information indicating a service time for triggering scheduling each time;
fourth information for determining the service time;
fifth information indicating an access policy;
sixth information for requesting a long-range transmission mode service; or
seventh information for determining whether to use the long-range transmission mode service.

15. An access point (AP) multi-link device (MLD) comprising:
a first affiliated access point (AP) affiliated to the AP MLD and configured to:
generate first signaling, indicating a mapping relationship between a traffic identifier and a link, and comprising first indication information, indicating a start time at which the mapping relationship takes effect for a first-time, second indication information indicating a duration in which the mapping relationship takes effect each time, and third indication information indicating an interval between consecutive start times or end times at which the mapping relationship takes effect; and
send the first signaling to a non-AP MLD associated with the AP MLD.

16. The AP MLD of claim 15, wherein the first signaling further comprises fourth indication information indicating a count of times that the mapping relationship takes effect, and wherein the count of times is greater than 1.

17. The AP MLD of claim 15, wherein the first AP is further configured to further send the first signaling by sending a beacon frame to the non-AP MLD associated with the AP MLD, and wherein the beacon frame comprises the first signaling.

18. The AP MLD of claim 15, further comprising a second affiliated AP, wherein
the first AP is further configured to perform data sending/receiving using the second affiliated AP through radio frequency transmit/receive chains of the first affiliated AP and the second affiliated AP when the first signaling indicates that the traffic identifier is not mapped to the link of the first affiliated AP during a time period in which the mapping relationship takes effect.

19. The AP MLD of claim 15, further comprising a second affiliated AP, wherein the first AP is further configured to:
send, to a first station using the second affiliated AP, second signaling instructing the first station to communicate with the second affiliated AP during a first time period in which the first station is woken up; and
perform, using the second affiliated AP through radio frequency transmit/receive chains of the first affiliated AP and the second affiliated AP during the first time period, data sending/receiving, wherein the first station is associated with the second affiliated AP, wherein a start time of the first time period is a first threshold later than a start time of a corresponding time period in which the mapping relationship takes effect, wherein an end time of the first time period is the first threshold earlier than an end time of the corresponding time period, wherein a first count of time periods in which the first station is woken up is the same as a second count of time periods in which the mapping relationship takes effect, and wherein the first signaling indicates that the traffic identifier is not mapped to the link of the first affiliated AP during a second time period in which the mapping relationship takes effect.

20. The AP MLD of claim 19, wherein the first AP is further configured to receive, from the first station and using the second affiliated AP, a request message requesting the second affiliated AP to periodically trigger scheduling of the first station for uplink transmission, and wherein the request message comprises information indicating an interval between two adjacent times of triggering of scheduling.
